(19) United States
(12) Patent Application Publication
(10) Pub. No.: US 2013/0321477 A1
(43) Pub. Date: Dec. 5, 2013

(54) DISPLAY DEVICES AND METHODS FOR GENERATING IMAGES THEREON ACCORDING TO A VARIABLE COMPOSITE COLOR REPLACEMENT POLICY

(71) Applicants: Jignesh Gandhi, Burlington, MA (US); Edward Buckley, Winchester, MA (US)

(72) Inventors: Jignesh Gandhi, Burlington, MA (US); Edward Buckley, Winchester, MA (US)

(73) Assignee: Pixtronix, Inc.

(21) Appl. No.: 13/486,819

(22) Filed: Jun. 1, 2012

(51) Int. Cl. G09G 5/10

(52) U.S. Cl. 345/690

(57) ABSTRACT

This disclosure provides systems, methods and display apparatus including pixels and a controller. The controller controls the amount of light emitted by the display apparatus for each of the pixels. Controlling the amount of light emitted includes controlling the luminance of at least four contributing colors emitted for the pixel. At least one of the contributing colors is a composite color which substantially corresponds to a combination of at least two of the remaining contributing colors, and the combined luminance of the at least four contributing colors results in a set of color tristimulus values for the pixel. The controller is further configured to generate substantially the same color tristimulus values for first and second pixels of an image frame by causing the display apparatus to emit a different composite color luminance for the first pixel than for the second pixel.

### TECHNICAL FIELD

This disclosure relates to display apparatus and methods for generating images thereon that reduce the incidence and/or severity of image artifacts.

### DESCRIPTION OF THE RELATED TECHNOLOGY

RGBW image formation processes are particularly, though not exclusively, useful for field sequential color (FSC) displays, i.e., displays in which the separate color subframes (sometimes referred to as subfields) are displayed in sequence, one color at a time. Examples of such displays include micromirror displays and digital shutter based displays. Other displays, such as liquid crystal displays (LCDs) and organic light emitting diode (OLED) displays, which show color subframes simultaneously using separate light modulators or light emitting elements, also may implement RGBW image formation processes. Depending on the display architecture, a display may generate multiple image subframes per color according to a time division gray scale technique, or a single image subframe per color where the emitters or modulators control light output using an analog grayscale technique.

Two image artifacts many FSC displays suffer from include dynamic false contouring (DFC) and color break-up (CBU). These artifacts are generally attributable to an uneven temporal distribution of light of the same (e.g., DFC) or different (e.g., CBU) colors reaching the eye for a given image frame.

One technique for reducing DFC and CBU is to provide “degeneracy” with respect to how various gray scales can be formed on a display. That is, the display can output a particular luminance value for a contributing color using multiple, different (or “degenerate”) sequences of pixel states. This flexibility allows the display to select sequences of pixel states that reduce these artifacts. Providing degeneracy, however, reduces the duty cycle of the display. Thus, there would be a benefit to identifying an alternative technique for varying how colors are displayed that does not require degeneracy.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display apparatus that includes a plurality of pixels and a controller. The controller is configured to control the amount of light emitted by the display apparatus for each of the pixels to display an image frame. Controlling the amount of light emitted by the display apparatus for a pixel includes controlling the luminance of at least four contributing colors emitted for the pixel in a plurality of corresponding subframe images or by a plurality of corresponding subpixels. At least one of the contributing colors is a composite color which substantially corresponds to a combination of at least two of the remaining contributing colors, and the combined luminance of the at least four contributing colors results in a pixel color having an associated set of color tristimulus values for the pixel. The controller is further configured to generate substantially the same color tristimulus values for first and second pixels of an image frame by causing the display apparatus to emit a different composite color luminance for the first pixel than for the second pixel.

In some illustrative implementations, the controller can be configured to select the luminance of the composite color to be emitted. In various implementations, the controller can select the luminance of the composite color based on one or more of a spatial pattern implemented by the controller, a graphical characteristic of the image frame, metadata received by the controller in association with the image frame, and the output of an ambient light sensor.

In certain illustrative implementations, the luminance of the composite color emitted for the first pixel can correspond to a first composite color replacement multiplier (a₁), and the luminance of the composite color emitted for the second pixel can correspond to a second composite color replacement multiplier (a₂). a₁ can be indicative of a fraction of a first full composite color replacement value (M₁) associated with the pixel color tristimulus values. M₁ corresponds substantially to the maximum theoretical composite color output that can be used to offset output of the at least two of the remaining contributing colors in the generation of the pixel color tristimulus values without substantially altering the chromaticity or brightness associated with the pixel color tristimulus values. a₂ can be indicative of a second, different fraction of M₁. The controller can further be configured to select the luminances of the composite color for the first pixel and the second pixel by obtaining values for a₁ and a₂. In some illustrative implementations, the controller can be configured to obtain values of a₁ and a₂ by processing image data associated with the image frame, image data associated with at least a second frame, metadata associated with the image frame, data indicative of a power battery level, data indicative of a power-usage mode, and/or the output of an ambient light sensor. In some illustrative implementations, the controller is configured to cause the display apparatus to emit the contributing colors for the image frame according to a field sequential color (FSC) display process.

Another innovative aspect of the subject matter described in this disclosure can be implemented in a controller for a display apparatus. The controller includes an image data input for receiving input pixel colors for a plurality of pixels of the display apparatus for an image frame and an image data processor. The image data processor is configured to determine for a given pixel of the image frame, based on a corresponding set of tristimulus values associated with a received input pixel color, luminance values for at least four contributing colors to be emitted by the display apparatus for the pixel in a plurality of corresponding subframe images or by a plurality of corresponding subpixels. At least one of the contributing colors is a composite color which substantially corresponds to a combination of at least two of the remaining contributing colors. The combined luminance of the at least four contributing colors results in an output pixel color having substantially the same set of tristimulus values as the color tristimulus values associated with the input pixel color. The image processor is further configured to determine substantially different composite color luminance values for at least two pixels having the same input pixel color. In some illustrative implementations, the composite color is either white or yellow and the contributing colors include at least two of red, green and blue.

In some illustrative implementations, the controller can be configured to select the luminance of the composite color to be emitted. In various implementations, the controller can select the luminance of the composite color based on one or more of a spatial pattern implemented by the controller, a graphical characteristic of the image frame, metadata received by the controller in association with the image frame and the output of an ambient light sensor.

In certain illustrative implementations, the luminance of the composite color emitted for the first pixel can correspond to a first composite color replacement multiplier (a₁), and the luminance of the composite color emitted for the second pixel can correspond to a second composite color replacement multiplier (a₂). a₁ is indicative of a fraction of a first full composite color replacement value (M_{I}) associated with the input pixel color. M₁ corresponds substantially to the maximum theoretical composite color output that can be used to offset output of the at least two of the remaining contributing colors in the generation of the output pixel color such that the chromaticity and brightness associated with the output pixel tristimulus values are substantially the same as the chromaticity and brightness associated with the input color tristimulus values. a₂ is indicative of a second, different fraction of M₁. The controller can further be configured to select the luminances of the composite color for the first pixel and the second pixel by obtaining values for a₁ and a₂.

Another innovative aspect of the subject matter described in this disclosure can be implemented in a controller for a display apparatus that includes an image data input for receiving input pixel colors for a plurality of pixels of the display apparatus for an image frame and an image data processor. The image data processor is configured to determine for a given pixel of the image frame, based on a corresponding received input pixel color, luminance values for at least four contributing colors to be emitted by the display apparatus for the pixel in a plurality of corresponding subframe images or by a plurality of corresponding subpixels. At least one of the contributing colors is a composite color which substantially corresponds to a combination of at least two of the remaining contributing colors, and the combined luminance of the at least four contributing colors results in an output pixel color for the pixel which is substantially similar to the input pixel color.

The luminance of the composite color emitted for a first pixel can correspond to a first composite color replacement multiplier (a₁). a₁ is indicative of a fraction of a first full composite color replacement value (M₁) associated with the input pixel color of the first pixel. M₁ corresponds substantially to the maximum theoretical composite color output that can be used to offset output of the at least two of the remaining contributing colors in the generation of the input pixel color of the first pixel on the display apparatus without the chromaticity or brightness associated with a set of tristimulus values for the output pixel color for the first pixel differing substantially from the chromaticity or brightness associated with a set of tristimulus values for the input pixel color for the first pixel. The luminance of the composite color emitted for a second pixel can correspond to a second composite color replacement multiplier (a₂), wherein a₂ is indicative of a fraction of a second full composite color replacement value (M₂) associated with the input pixel color of the second pixel. M₂ corresponds substantially to the maximum theoretical composite color output that can be used to offset output of the at least two of the remaining contributing colors in the generation of the input pixel color of the second pixel on the display apparatus without the chromaticity or brightness associated with a set of tristimulus values for the output pixel color for the second pixel differing substantially from the chromaticity or brightness associated with a set of tristimulus values for the input pixel color for the second pixel. The controller can further be configured to select a₁ and a₂ such that a₁ is greater than a₂.

In some illustrative implementations, the controller can be configured to determine values for M₁ and M₂ and determine luminance values for each of the contributing colors for the first and second pixels based on the values for a₁, a₂, M₁ and M₂. In some other illustrative implementations, the controller can be further configured to select, for each of the contributing colors, states of the first and second pixel for each subframe image or subpixel associated with the image frame. In such implementations, the selection of the states of the first and second pixel is based on the luminance values for the contributing colors and the values of a₁ and a₂ determined by the controller.

In some other implementations, the controller can store at least two data structures identifying series of pixel states for generating a plurality of luminance levels of at least one contributing color. The controller can be configured to select, for the first pixel, one of the data structures for utilization based on the value of a₁. The controller can further be configured to select, for the second pixel, one of the data structures for utilization based on the value of a₂.

Details of one or more implementations of the subject matter described in this specification are set forth in the accompanying drawings and the description below. Although the examples provided in this summary are primarily described in terms of MEMS-based displays, the concepts provided herein may apply to other types of displays, such as LCD, OLED, electrophoretic and field emission displays. Other features, aspects and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view MEMS-based display apparatus.

FIG. 1B shows a block diagram of an example host device.

FIG. 2A shows a perspective view of an example shutter-based light modulator.

FIG. 2B shows a cross sectional view of an example non-shutter-based light modulator.

FIG. 2C shows an example of a field sequential liquid crystal display operating in optically compensated bend (OCB) mode.

FIG. 3 shows a perspective view of an example array of shutter-based light modulators.

FIG. 4 shows an example timing diagram corresponding to a display process for displaying images using FSC.

FIG. 5 shows an example timing diagram for a display process employed by a controller for the formation of an image using a series of sub-frame images in a binary time division gray scale process.

FIG. 6 shows an example timing diagram that corresponds to a coded-time division gray scale addressing process in which image frames are displayed by displaying four sub-frame images for each color component of the image frame.

FIG. 7 shows a block diagram of an example controller for use in a display.

FIG. 8 shows a flow diagram of an example process for displaying images according to a variable composite color replacement policy.

FIG. 9 shows a diagram depicting perceived brightness gains obtained at various ambient light levels by outputting white light using a combination of saturated colors due to the HK Effect.

FIGS. 10A-10C show example graphical depictions of how output luminance values for a pixel can be determined based on a value of a.

### DETAILED DESCRIPTION

Certain display apparatus have been implemented that use an image formation process that generates a combination of separate color subframe images, which the human visual system (including the eye, optic nerves and relevant portions of the brain) (HVS), blends together to form a single image frame. One example of this type of image formation process is referred to as RGBW image formation, the name deriving from the fact that images are generated using a combination of red (R), green (G), blue (B) and white (W) sub-images. Each of the colors used to form a subframe image is referred to herein, generically, as a “contributing” color. Certain contributing colors also may be referred to either as “component” or “composite” colors. A composite color is a color that is substantially the same as the combination of at least two component colors. For example, red, green and blue, when combined, are perceived by viewers of a display as white. Thus, for an RGBW image formation process, as used herein, white would be referred to as a “composite color” having “component colors” of red, green and blue.

Intelligently controlling component color replacement with a composite color can yield both greater energy efficiency and a reduction in image artifacts. For a given image pixel in an image frame, some portion of the luminance output by the display using component colors can instead be output using the composite color. The display apparatus can replace the component color luminance up to a theoretical full composite color replacement value, M, without substantially altering the chromaticity or brightness of the generated color. In some implementations, this full composite color replacement value, M, can be substantially equal to the luminance level for the pixel of the component color having the lowest luminance. The display apparatus can thus generate a given pixel color using anywhere from no composite color output up to a composite color output equal to M. The composite color luminance level output by the display can be characterized by a composite color replacement multiplier, a, equal to the output composite color luminance value divided by M.

By selecting different values of a, a display controller can variably adjust the luminance of composite color light used in the formation of an output pixel color. In doing so, the display controller also adjusts the luminance level of the component color light sources. The display controller can, based on this principle, select values of a that result in the display outputting component color luminance levels that are favorable from an image artifact reduction perspective. Thus, varying a provides another option, instead of or in addition to employing code word degeneracy, for altering the temporal distribution of light emission across a display, thereby mitigating related image artifacts.

In various implementations, a display controller is configured, as part of converting an input image frame into a set of sequentially presented sub-frames or simultaneously displayed subfields, to obtain a value of a for each pixel being displayed. It then can be implemented to identify color-specific luminance levels for each contributing color based on the obtained a value. The display controller can use the same value of a for every pixel in an image frame, or it may obtain a separate value of a for every pixel or for groups of pixels. The controller may obtain the a values from an input data stream or control signal, or it may determine appropriate values of a based on a variety of parameters, such as image characteristics of an image frame.

In certain implementations, in addition or in the alternative to taking into account image characteristics in determining values for a, the display controller is configured to consider ambient light levels in its determination. Specifically, the controller selects levels of a that balance the efficiency gains that can be achieved by using a broad band light source (such as a white LED) to provide luminance against the ambient light level-dependent Helmholtz-Kohlrausch (or HK) Effect. The HK Effect refers to the phenomenon by which the human visual system (HVS) perceives white light formed from a combination of saturated colors as being brighter than an equivalent output from a broadband light source. This effect may offset, and in certain conditions can completely negate, any efficiency gains achieved by using a higher-efficiency composite color light source.

Particular implementations of the subject matter described in this disclosure can be implemented to realize one or more of the following potential advantages. Intelligently controlling component color replacement with a composite color can yield both greater energy efficiency and a reduction in image artifacts. From a power perspective, varying the degree of component color replacement allows a display to intelligently trade off the power savings that can be achieved using broadband light sources with the ambient-light dependent power savings obtained by using saturated light sources due to the HK effect. From an image quality perspective, controlling a composite color replacement factor provides an additional degree of freedom for displays to manage image artifacts, such as DFC and CBU. First, increased composite color output can decrease CBU. Moreover, altering composite color output level for a pixel correspondingly alters the output levels of its corresponding component colors. Thus, being able to control composite color output levels provides control of the component color output levels without altering output chromaticity or brightness while avoiding component color outputs that may lead to DFC.

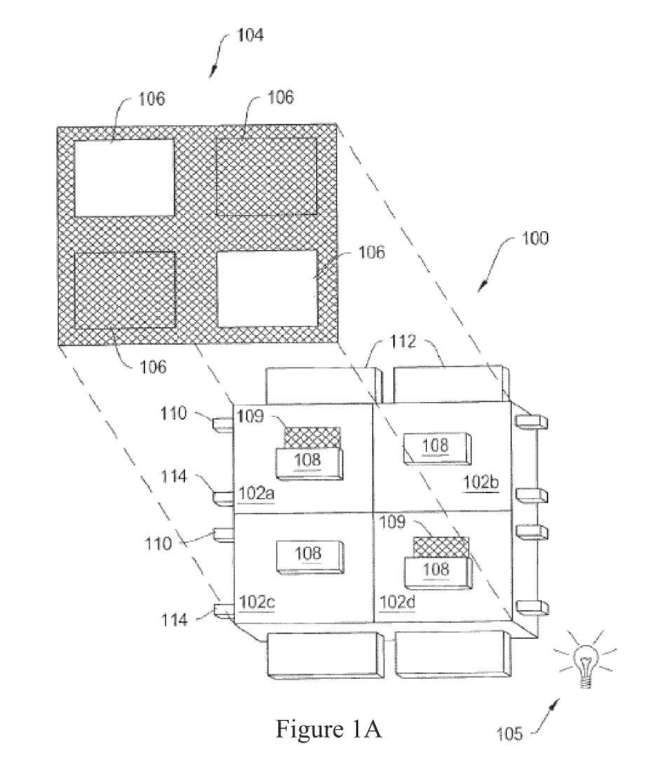

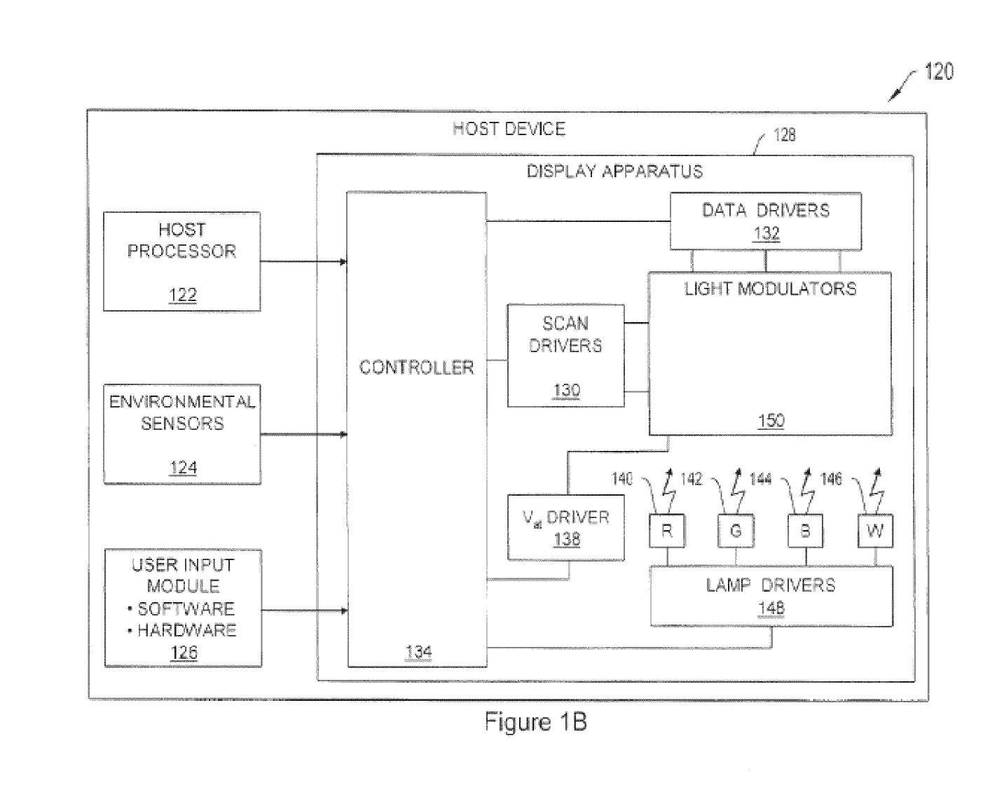

FIG. 1A shows a schematic diagram of an example direct-view MEMS-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (e.g., interconnects 110, 112 and 114), including at least one write-enable interconnect 110 (also referred to as a “scan-line interconnect”) per row of pixels, one data interconnect 112 for each column of pixels and one common interconnect 114 providing a common voltage to all pixels, or at least to pixels from both multiple columns and multiples rows in the display apparatus 100. In response to the application of an appropriate voltage (the “write-enabling voltage, VWE”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, e.g., transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows a block diagram 120 of an example host device. Example host devices include cell phones, smart phones, PDAs, MP3 players, tablets, e-reader, televisions, etc. The host device includes a display apparatus 128, a host processor 122, environmental sensors 124, a user input module 126 and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146 and lamp drivers 148. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the light modulators, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3, or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in predetermined sequences grouped by rows and by image frames. The data drivers 132 can include series to parallel data converters, level shifting and for some applications digital to analog voltage converters.

The display apparatus optionally includes a set of common drivers 138, also referred to as common voltage sources. In some implementations, the common drivers 138 provide a DC common potential to all light modulators within the array of light modulators, for instance by supplying voltage to a series of common interconnects 114. In some other implementations, the common drivers 138, following commands from the controller 134, issue voltage pulses or signals to the array of light modulators, for instance global actuation pulses which are capable of driving and/or initiating simultaneous actuation of all light modulators in multiple rows and columns of the array.

All of the drivers (e.g., scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array of pixels, the output of voltages from the data drivers 132 and the output of voltages that provide for light modulator actuation.

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz. In some implementations the setting of an image frame to the array is synchronized with the illumination of the lamps 140, 142, 144 and 146 such that alternate image frames are illuminated with an alternating series of colors, such as red, green and blue. The image frames for each respective color is referred to as a color subframe. In this technique, referred to as the field sequential color technique, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green and blue.

In some implementations, where the display apparatus 100 is designed for the digital switching of shutters 108 between open and closed states, the controller 134 forms an image by the technique of time division gray scale, as previously described. In some other implementations, the display apparatus 100 can provide gray scale through the use of multiple shutters 108 per pixel.

In some implementations the data for an image state 104 is loaded by the controller 134 to the modulator array by a sequential addressing of individual rows, also referred to as scan lines. For each row or scan line in the sequence, the scan driver 130 applies a write-enable voltage to the write enable interconnect 110 for that row of the array, and subsequently the data driver 132 supplies data voltages, corresponding to desired shutter states, for each column in the selected row. This process repeats until data has been loaded for all rows in the array. In some implementations, the sequence of selected rows for data loading is linear, proceeding from top to bottom in the array. In some other implementations, the sequence of selected rows is pseudo-randomized, in order to minimize visual artifacts. And in some other implementations, the sequencing is organized by blocks, where, for a block, the data for only a certain fraction of the image state 104 is loaded to the array, for instance by addressing only every fifth row of the array in sequence.

In some implementations, the process for loading image data to the array is separated in time from the process of actuating the shutters 108. In these implementations, the modulator array may include data memory elements for each pixel in the array and the control matrix may include a global actuation interconnect for carrying trigger signals, from common driver 138, to initiate simultaneous actuation of shutters 108 according to data stored in the memory elements.

In alternative implementations, the array of pixels and the control matrix that controls the pixels may be arranged in configurations other than rectangular rows and columns. For example, the pixels can be arranged in hexagonal arrays or curvilinear rows and columns. In general, as used herein, the term scan-line shall refer to any plurality of pixels that share a write-enabling interconnect.

The host processor 122 generally controls the operations of the host. For example, the host processor may be a general or special purpose processor for controlling a portable electronic device. With respect to the display apparatus 128, included within the host device 120, the host processor outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device. The environmental sensor module receives data about the ambient environment, such as temperature and or ambient lighting conditions. The sensor module 124 can be programmed to distinguish whether the device is operating in an indoor or office environment versus an outdoor environment in bright daylight versus and outdoor environment at nighttime. The sensor module communicates this information to the display controller 134, so that the controller can optimize the viewing conditions in response to the ambient environment.

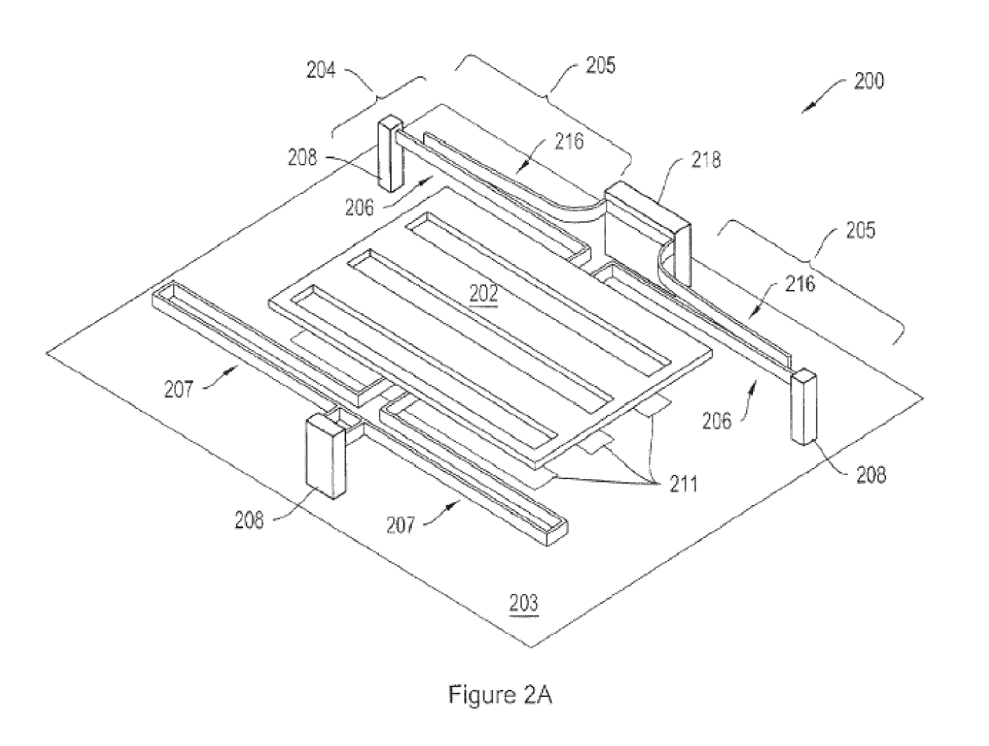

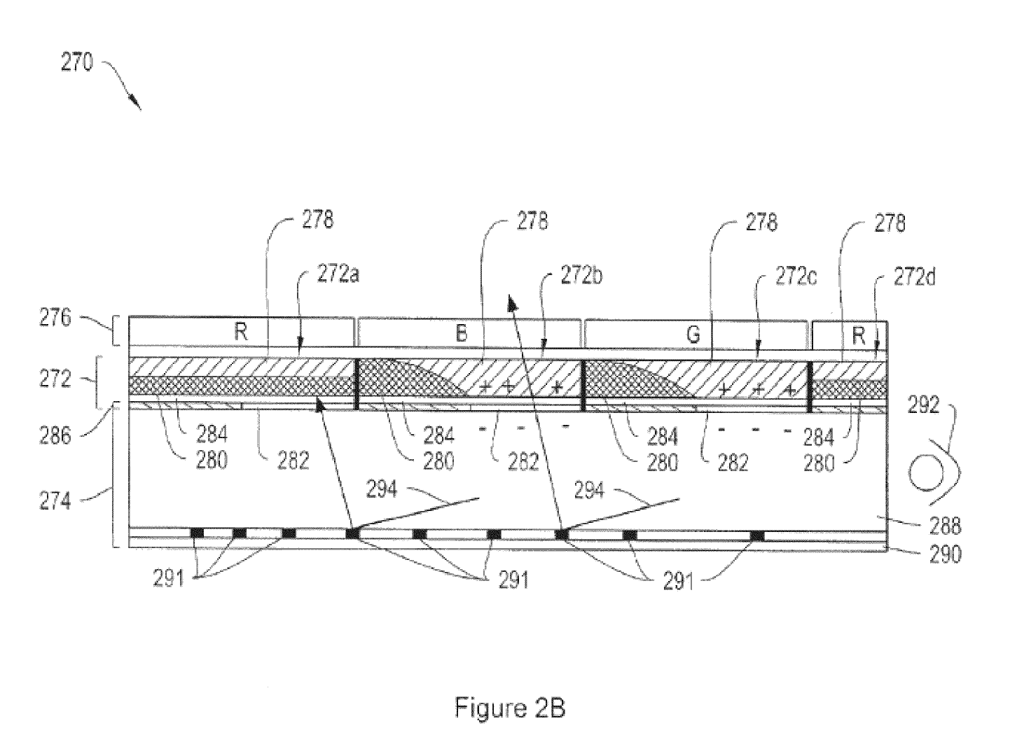

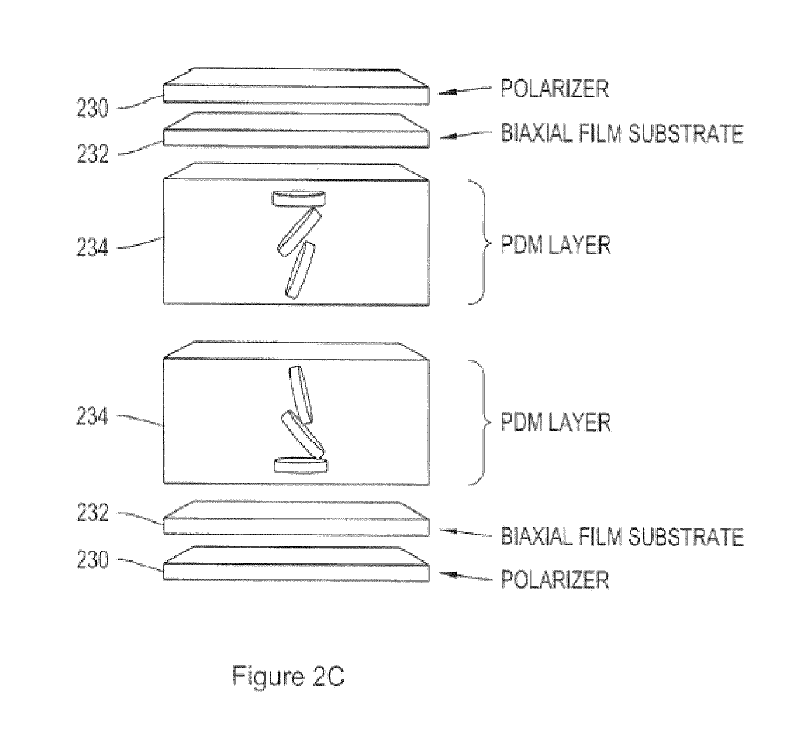

FIG. 2A shows a perspective view of an example shutter-based light modulator 200. The shutter based light modulator 200 is suitable for incorporation into the direct-view MEMS-based display apparatus 100 depicted in FIG. 1A. The light modulator 200 includes a shutter 202 coupled to an actuator 204. The actuator 204 can be formed from two separate compliant electrode beam actuators 205 (the “actuators” 205). The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The surface includes one or more aperture holes 211 for admitting the passage of light. The load anchors 208 physically connect the compliant load beams 206 and the shutter 202 to the surface 203 and electrically connect the load beams 206 to a bias voltage, in some instances, ground.

If the substrate is opaque, such as silicon, then aperture holes 211 are formed in the substrate by etching an array of holes through the substrate 204. If the substrate 204 is transparent, such as glass or plastic, then the first block of the processing sequence involves depositing a light blocking layer onto the substrate and etching the light blocking layer into an array of holes 211. The aperture holes 211 can be generally circular, elliptical, polygonal, serpentine, or irregular in shape.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely towards the drive anchor 218. The compliant members 206 act as springs, such that when the voltage across the beams 206 and 216 potential is removed, the load beams 206 push the shutter 202 back into its initial position, releasing the stress stored in the load beams 206.

A light modulator, such as light modulator 200, incorporates a passive restoring force, such as a spring, for returning a shutter to its rest position after voltages have been removed. Other shutter assemblies can incorporate a dual set of “open” and “closed” actuators and separate sets of “open” and “closed” electrodes for moving the shutter into either an open or a closed state.

There are a variety of processess by which an array of shutters and apertures can be controlled via a control matrix to produce images, in many cases moving images, with appropriate luminance level. In some cases control is accomplished by means of a passive matrix array of row and column interconnects connected to driver circuits on the periphery of the display. In other cases it is appropriate to include switching and/or data storage elements within each pixel of the array (the so-called active matrix) to improve the speed, the luminance level and/or the power dissipation performance of the display.

The controller functions described herein are not limited to controlling shutter-based MEMS light modulators, such as the light modulators described above. FIG. 2B shows a cross sectional view of an example non-shutter-based light modulator. Specifically, FIG. 2B shows a cross sectional view of an electrowetting-based light modulation array 270. The light modulation array 270 includes a plurality of electrowetting-based light modulation cells 272a-d (generally “cells 272”) formed on an optical cavity 274. The light modulation array 270 also includes a set of color filters 276 corresponding to the cells 272.

Each cell 272 includes a layer of water (or other transparent conductive or polar fluid) 278, a layer of light absorbing oil 280, a transparent electrode 282 (made, for example, from indium-tin oxide) and an insulating layer 284 positioned between the layer of light absorbing oil 280 and the transparent electrode 282. In the implementation described herein, the electrode takes up a portion of a rear surface of a cell 272.

The remainder of the rear surface of a cell 272 is formed from a reflective aperture layer 286 that forms the front surface of the optical cavity 274. The reflective aperture layer 286 is formed from a reflective material, such as a reflective metal or a stack of thin films forming a dielectric mirror. For each cell 272, an aperture is formed in the reflective aperture layer 286 to allow light to pass through. The electrode 282 for the cell is deposited in the aperture and over the material forming the reflective aperture layer 286, separated by another dielectric layer.

The remainder of the optical cavity 274 includes a light guide 288 positioned proximate the reflective aperture layer 286, and a second reflective layer 290 on a side of the light guide 288 opposite the reflective aperture layer 286. A series of light redirectors 291 are formed on the rear surface of the light guide, proximate the second reflective layer. The light redirectors 291 may be either diffuse or specular reflectors. One or more light sources 292 inject light 294 into the light guide 288.

In an alternative implementation, an additional transparent substrate is positioned between the light guide 290 and the light modulation array 270. In this implementation, the reflective aperture layer 286 is formed on the additional transparent substrate instead of on the surface of the light guide 290.

In operation, application of a voltage to the electrode 282 of a cell (for example, cell 272b Or 272c) causes the light absorbing oil 280 in the cell to collect in one portion of the cell 272. As a result, the light absorbing oil 280 no longer obstructs the passage of light through the aperture formed in the reflective aperture layer 286 (see, for example, cells 272b and 272c). Light escaping the backlight at the aperture is then able to escape through the cell and through a corresponding color filter (for example, red, green, or blue) in the set of color filters 276 to form a color pixel in an image. When the electrode 282 is grounded, the light absorbing oil 280 covers the aperture in the reflective aperture layer 286, absorbing any light 294 attempting to pass through it.

The area under which oil 280 collects when a voltage is applied to the cell 272 constitutes wasted space in relation to forming an image. This area cannot pass light through, whether a voltage is applied or not, and therefore, without the inclusion of the reflective portions of reflective apertures layer 286, would absorb light that otherwise could be used to contribute to the formation of an image. However, with the inclusion of the reflective aperture layer 286, this light, which otherwise would have been absorbed, is reflected back into the light guide 290 for future escape through a different aperture. The electrowetting-based light modulation array 270 is not the only example of a non-shutter-based MEMS modulator suitable for control by the control matrices described herein. Other forms of non-shutter-based MEMS modulators could likewise be controlled by various ones of the controller functions described herein without departing from the scope of this disclosure.

FIG. 2C shows an example of a field sequential liquid crystal display operating in optically compensated bend (OCB) mode. In addition to MEMS displays, this disclosure also may make use of field sequential color (FSC) liquid crystal displays, including for example, the liquid crystal display operating in optically compensated bend (OCB) mode as shown in FIG. 2C. Coupling an OCB mode LCD display with the FSC technique may allow for low power and high resolution displays. The LCD display depicted in FIG. 2C is composed of a circular polarizer 230, a biaxial retardation film 232 and a polymerized discotic material (PDM) 234. The biaxial retardation film 232 contains transparent surface electrodes with biaxial transmission properties. These surface electrodes act to align the liquid crystal molecules of the PDM layer in a particular direction when a voltage is applied across them.

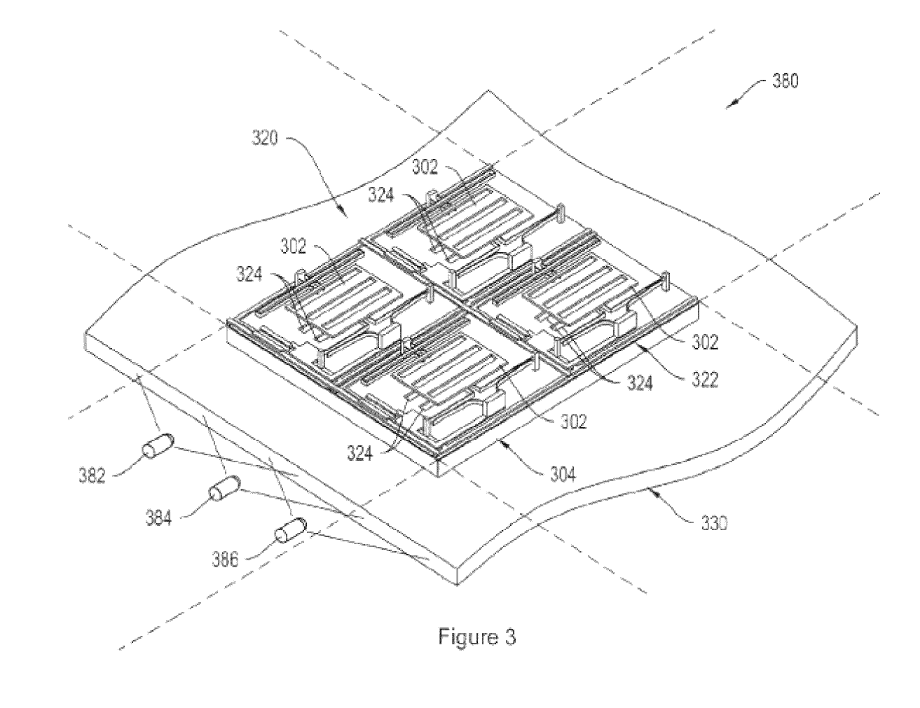

FIG. 3 shows a perspective view of an array 320 of shutter-based light modulators 320. The array of shutter-based light modulators 320 is part of a display 380 and are disposed on top of backlight 350. In some implementations, the backlight 350 is made of a transparent material, i.e., glass or plastic, and functions as a light guide for evenly distributing light from lamps 382, 384 and 386 throughout the display plane. When assembling the display 380 as a field sequential display, the lamps 382, 384 and 386 can be lamps of different colors, such as, red, green and blue or cyan, magenta and yellow lamps.

A number of different types of lamps 382, 384 and 386 can be employed in the displays, including without limitation: incandescent lamps, fluorescent lamps, lasers, or light emitting diodes (LEDs). Further, lamps 382, 384 and 386 of the direct view display 380 can be combined into a single assembly containing multiple lamps. For instance a combination of red, green and blue LEDs can be combined with or substituted for a white LED in a small semiconductor chip, or assembled into a small multi-lamp package. Similarly each lamp can represent an assembly of 4-color LEDs, for instance a combination of red, yellow, green and blue LEDs, a combination of cyan, magenta, yellow and white LEDs, or a combination of red, green, blue and white LEDs. In some other implementations, additional LEDs may be included in a lamp assembly. For example, if using five colors, a lamp assembly may include red, green, blue, cyan and yellow LEDs. In some other implementations, a lamp assembly may include white, orange, blue, purple and green LEDs or white, blue, yellow, red and cyan LEDs. If using six colors, the lamp assembly may include red, green, blue, cyan, magenta and yellow LEDs or white, cyan, magenta, yellow, orange and green LEDs.

The shutter assemblies 302 function as light modulators. By use of electrical signals from the associated controller, the shutter assemblies 302 can be set into either an open or a closed state. The open shutters allow light from the backlight 350 to pass through to the viewer, thereby forming a direct view image.

In some implementations, the light modulators are formed on the surface of substrate 304 that faces away from the backlight 350 and toward the viewer. In some other implementations, the substrate 304 can be reversed, such that the light modulators are formed on a surface that faces toward the light guide. In these implementations it is sometimes preferable to form an aperture layer, such as aperture layer 322, directly onto the top surface of the backlight 350. In some other implementations, it is useful to interpose a separate piece of glass or plastic between the light guide and the light modulators, such separate piece of glass or plastic containing an aperture layer, such as aperture layer 322, and associated aperture holes, such as aperture holes 324. It is preferable that the spacing between the plane of the shutter assemblies 302 and the aperture layer 322 be kept as close as possible, preferably less than 10 microns, in some cases as close as 1 micron.

In some displays, color pixels are generated by illuminating groups of light modulators corresponding to different colors, for example, red, green and blue. Each light modulator in the group has a corresponding filter to achieve the desired color. The filters, however, absorb a great deal of light, in some cases as much as 60% of the light passing through the filters, thereby limiting the efficiency and brightness of the display. In addition, the use of multiple light modulators per pixel decreases the amount of space on the display that can be used to contribute to a displayed image, further limiting the brightness and efficiency of such a display.

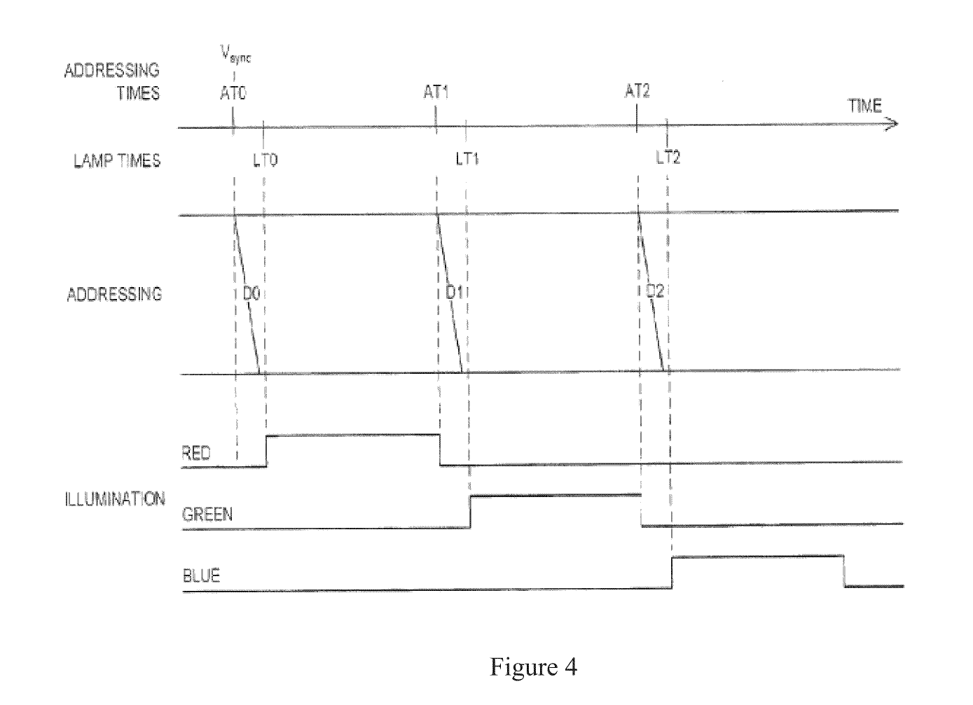

FIG. 4 shows an example timing diagram 400 corresponding to a display process for displaying images using field sequential color (FSC). The timing diagram 400 can be implemented, for example, by a display apparatus 128 described in FIG. 1B. The timing diagrams included herein, including the timing diagram 400, depicted in FIGS. 4, 5 and 6 conform to the following conventions: the top portions of the timing diagrams illustrate light modulator addressing events and the bottom portions illustrate lamp illumination events.

The addressing portions depict addressing events by diagonal lines spaced apart in time. Each diagonal line corresponds to a series of individual data loading events during which data is loaded into each row of an array of light modulators, one row at a time. Depending on the control matrix used to address and drive the modulators included in the display, each loading event may require a waiting period to allow the light modulators in a given row to actuate. In some implementations, all rows in the array of light modulators are addressed prior to actuation of any of the light modulators. Upon completion of loading data into the last row of the array of light modulators, all light modulators are actuated substantially simultaneously.

Lamp illumination events are illustrated by pulse trains corresponding to each color of lamp included in the display. Each pulse indicates that the lamp of the corresponding color is illuminated, thereby displaying the subframe image loaded into the array of light modulators in the immediately preceding addressing event.

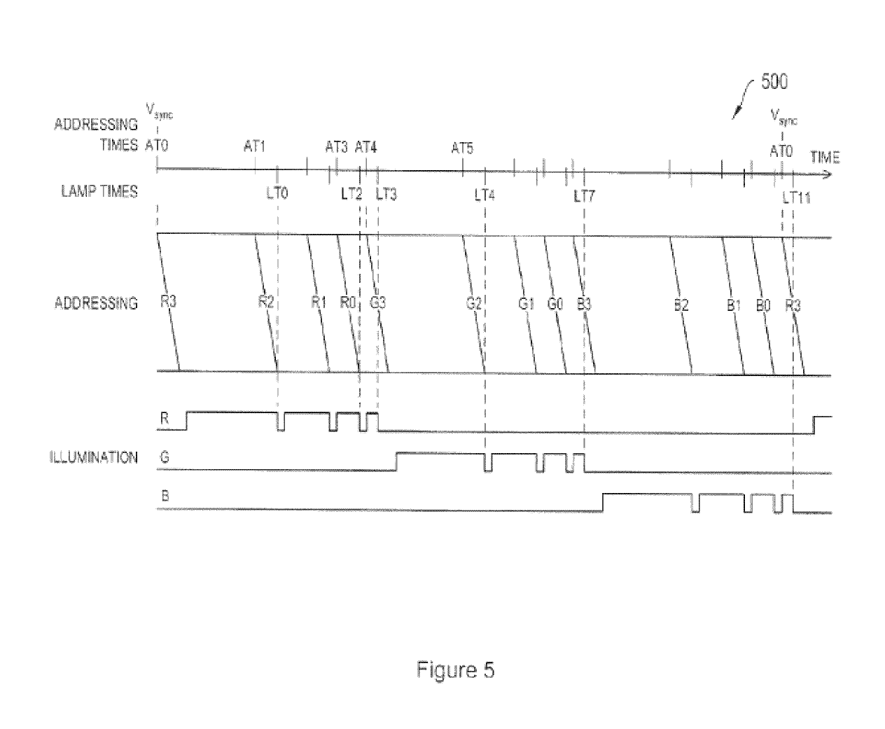

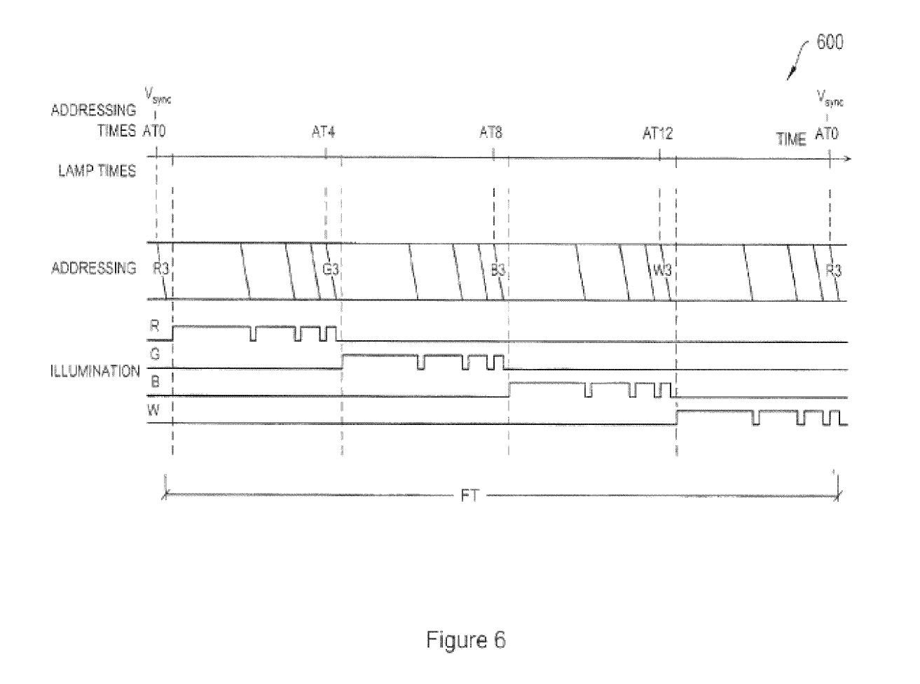

The time at which the first addressing event in the display of a given image frame begins is labeled on each timing diagram as AT0. In most of the timing diagrams, this time falls shortly after the detection of a voltage pulse vsync, which precedes the beginning of each video frame received by a display. The times at which each subsequent addressing event takes place are labeled as AT1, AT2, . . . AT(n−1), where n is the number of subframe images used to display the image frame. In some of the timing diagrams, the diagonal lines are further labeled to indicate the data being loaded into the array of light modulators. For example, in the timing diagram depicted in FIG. 4, D0 represents the first data loaded into the array of light modulators for a frame and D(n−1) represents the last data loaded into the array of light modulators for the frame. In the timing diagrams depicted in FIGS. 5 and 6, the data loaded during each addressing event corresponds to a bitplane.

A bitplane is a coherent set of data identifying desired modulator states for modulators in multiple rows and multiple columns of an array of light modulators. Moreover, each bitplane corresponds to one of a series of subframe images derived according to a binary coding scheme. That is, each subframe image for a contributing color of an image frame is weighted according to a binary series 1, 2, 4, 8, 16, etc. The bitplane with the lowest weighting is referred to as the least significant bitplane and is labeled in the timing diagrams and referred to herein by the first letter of the corresponding contributing color followed by the number 0. For each next-most significant bitplane for the contributing colors, the number following the first letter of the contributing color increases by one. For example, for an image frame broken into 4 bitplanes per color, the least significant red bitplane is labeled and referred to as the R0 bitplane. The next most significant red bitplane is labeled and referred to as R1, and the most significant red bitplane is labeled and referred to as R3.

Lamp-related events are labeled as LT0, LT1, LT2 . . . LT(n−1). The lamp-related event times labeled in a timing diagram, depending on the timing diagram, either represent times at which a lamp is illuminated or times at which a lamp is extinguished. The meaning of the lamp times in a particular timing diagram can be determined by comparing their position in time relative to the pulse trains in the illumination portion of the particular timing diagram. Specifically referring back to the timing diagram 400 depicted in FIG. 4, to display an image frame according to the timing diagram 400, a single subframe image is used to display each of three contributing colors of an image frame. First, data, D0, indicating modulator states desired for a red subframe image are loaded into an array of light modulators beginning at time AT0. After addressing is complete, the red lamp is illuminated at time LT0, thereby displaying the red subframe image. Data, D1, indicating modulator states corresponding to a green subframe image are loaded into the array of light modulators at time AT1. A green lamp is illuminated at time LT1. Finally, data, D2, indicating modulator states corresponding to a blue subframe image are loaded into the array of light modulators and a blue lamp is illuminated at times AT2 and LT2, respectively. The process then repeats for subsequent image frames to be displayed.

The number of luminance levels achievable by a display that forms images according to the timing diagram depicted in FIG. 4 depends on how finely the state of each light modulator can be controlled. For example, if the light modulators are binary in nature, i.e., they can only be on or off, the display will be limited to generating 8 different colors. The number of luminance levels can be increased for such a display by providing light modulators than can be driven into additional intermediate states. In some implementations related to the field sequential technique depicted in FIG. 4, MEMS-based or other light modulators can be provided which exhibit an analog response to applied voltage. The number of luminance levels achievable in such a display is limited only by the resolution of digital to analog converters which are supplied in conjunction with data voltage sources.

Alternatively, finer luminance level can be generated if the time period used to display each subframe image is split into multiple time periods, each having its own corresponding subframe image. For example, with binary light modulators, a display that forms two subframe images of equal length and light intensity per contributing color can generate 27 different colors instead of 8. Luminance level techniques that break each contributing color of an image frame into multiple subframe images are referred to, generally, as time division gray scale techniques.

FIG. 5 shows an example timing diagram for a display process 500 employed by a controller for the formation of an image using a series of sub-frame images in a binary time division gray scale process. In some implementations, the display process 500 may be implemented by the controller 134 depicted in FIG. 1B. Thus, the display process 500 is described below in reference to FIG. 5 and FIG. 1B.

Referring to FIGS. 1B ands 5, the controller 134, used with the display process 500, is responsible for coordinating multiple operations in a timed sequence (time varies from left to right in FIG. 5). The controller 134 determines when data elements of a subframe data set are transferred out of the frame buffer and into the data drivers 132. The controller 134 also sends trigger signals to enable the scanning of rows in the array by means of scan drivers 130, thereby enabling the loading of data from the data from drivers 132 into the pixels of the array. The controller 134 also governs the operation of the lamp drivers 148 to enable the illumination of the lamps 140, 142 and 144 (the white lamp 146 is not employed in the display process 500). The controller 134 also can send trigger signals to the common drivers 138 which enable functions such as the global actuation of shutters substantially simultaneously in multiple rows and columns of the array.

The process of forming an image in the display process 500 includes, for each subframe image, the loading of a subframe data set out of the frame buffer and into the array. A subframe data set includes information about the desired states of modulators (e.g., open or closed) in multiple rows and multiple columns of the array. For binary time division gray scale, a separate subframe data set is transmitted to the array for each bit level within each color in the binary coded word for gray scale. For the case of binary coding, a subframe data set is referred to as a bit plane. The display process 500 refers to the loading of 4 bitplane data sets in each of the three colors red, green and blue. These data sets are labeled as R0-R3 for red, G0-G3 for green and B0-B3 for blue. For economy of illustration, only 4 bit levels per color are illustrated in the display process 500, although it will be understood that alternate image forming sequences are possible that employ 6, 7, 8, or 10, or even more, bit levels per color.

The display process 500 refers to a series of addressing times AT0, AT1, AT2, etc. These times represent the beginning times or trigger times for the loading of particular bitplanes into the array. The first addressing time AT0 coincides with Vsync, which is a trigger signal commonly employed to denote the beginning of an image frame. The display process 500 also refers to a series of lamp illumination times LT0, LT1, LT2, etc., which are coordinated with the loading of the bitplanes. These lamp triggers indicate the times at which the illumination from one of the lamps 140, 142 and 144 is extinguished. The illumination pulse periods and amplitudes for each of the red, green and blue lamps are illustrated along the bottom of FIG. 5, and labeled along separate lines by the letters “R,” “G” and “B.”

The loading of the first bitplane R3 commences at the trigger point AT0. The second bitplane to be loaded, R2, commences at the trigger point AT1. The loading of each bitplane requires a substantial amount of time. For instance the addressing sequence for bitplane R2 commences in this illustration at AT1 and ends at the point LT0. The addressing or data loading operation for each bitplane is illustrated as a diagonal line in timing diagram 500. The diagonal line represents a sequential operation in which individual rows of bitplane information are transferred out of the frame buffer, one at a time, into the data drivers 132 (depicted in FIG. 1B) and from there into the array. The loading of data into each row or scan line requires anywhere from 1 microsecond to 100 microseconds. The complete transfer of multiple rows or the transfer of a complete bitplane of data into the array can take anywhere from about 100 microseconds to about 5 milliseconds, depending on the number of rows in the array.

In the display process 500, the process for loading image data to the array is separated in time from the process of moving or actuating associated light modulators. For some implementations, a light modulator array includes data memory elements, such as a storage capacitor, for each pixel in the array and the process of data loading involves only the storing of data (i.e., on-off or open-close instructions) in the memory elements. The light modulators do not move or actuate until a global actuation signal is generated by one of the common drivers 138 (depicted in FIG. 1B). The global actuation signal is not sent by the controller 134 (also depicted in FIG. 1B) until all of the data has been loaded to the array. At the designated time, all of the light modulators designated for motion or change of state are caused to move substantially simultaneously by the global actuation signal. A small gap in time is indicated between the end of a bitplane loading sequence and the illumination of a corresponding lamp. This is the time required for global actuation of the shutters. The global actuation time is illustrated, for example, between the trigger points LT2 and AT4. It is preferable that all lamps be extinguished during the global actuation period so as not to confuse the image with illumination of light modulators that are only partially actuated. The amount of time required for global actuation of light modulators, such as the shutter assemblies 320 depicted in FIG. 3, can take, depending on the design and construction of the light modulators, anywhere from about 10 microseconds to about 500 microseconds.

For the example of the display process 500 the controller 134 is programmed to illuminate just one of the lamps after the loading of each bitplane, where such illumination is delayed after loading data of the last scan line in the array by an amount of time equal to the global actuation time. Note that loading of data corresponding to a subsequent bitplane can begin and proceed while the lamp remains on, since the loading of data into the memory elements of the array does not immediately affect the position of the shutters.

Each of the subframe images, e.g., those associated with bitplanes R3, R2, R1 and R0 is illuminated by a distinct illumination pulse from the red lamp 140 (depicted in FIG. 1B), indicated in the “R” line at the bottom of FIG. 5. Similarly, each of the subframe images associated with bitplanes G3, G2, G1 and G0 is illuminated by a distinct illumination pulse from the green lamp 142 (depicted in FIG. 1B), indicated by the “G” line at the bottom of FIG. 5. The illumination values (for this example the length of the illumination periods) used for each subframe image are related in magnitude by the binary series 8, 4, 2, 1, respectively. This binary weighting of the illumination values enables the expression or display of a gray scale value coded in binary words, where each bitplane contains the pixel on-off data corresponding to just one of the place values in the binary word. The commands that emanate from the controller 134 (depicted in FIG. 1B) ensure not only the coordination of the lamps with the loading of data but also the correct relative illumination period associated with each data bitplane.

A complete image frame is produced in the display process 500 between the two subsequent trigger signals Vsync. A complete image frame in the display process 500 includes the illumination of 4 bitplanes per color. For a 60 Hz frame rate the time between Vsync signals is 16.6 milliseconds. The time allocated for illumination of the most significant bitplanes (R3, G3 and B3) can be in this example approximately 2.4 milliseconds each. By proportion then, the illumination times for the next bitplanes R2, G2 and B2 would be 1.2 milliseconds. The least significant bitplane illumination periods, R0, G0 and B0, would be 300 microseconds each. If greater bit resolution were to be provided, or more bitplanes desired per color, the illumination periods corresponding to the least significant bitplanes would require even shorter periods, substantially less than 100 microseconds each.

It may be useful, in the development or programming of the controller 134 (depicted in FIG. 1B), to co-locate or store all of the critical sequencing parameters governing expression of luminance level in a sequence table, sometimes referred to as the sequence table store. An example of a table representing the stored sequence parameters is listed below as Table 1. The sequence table lists, for each of the subframes or “fields” a relative addressing time (e.g., AT0, at which the loading of a bitplane begins), the memory location of associated bitplanes to be found in buffer memory (e.g., location M0, M1, etc.), an identification code for one of the lamps (e.g., R, G or B), and a lamp time (e.g., LT0, which in this example determines the time at which the lamp is turned off).

TABLE 1
Sequence Table 1

| | Field | Field | Field | Field | Field | Field | Field | | Field | Field |
|---|---|---|---|---|---|---|---|---|---|---|
| | 1 | 2 | 3 | 4 | 5 | 6 | 7 | . . . | n − 1 | n |
| addressing time | AT0 | ATI | AT2 | AT3 | AT4 | AT5 | AT6 | . . . | AT(n − 1) | ATn |
| memory | M0 | M1 | M2 | M3 | M4 | M4 | M6 | . . . | M(n − ) | Mn |
| location of sub- | | | | | | | | | | |
| frame data set | | | | | | | | | | |
| lamp ID | R | R | R | R | G | G | G | . . . | B | B |
| lamp time | LT0 | LT1 | LT2 | LT3 | LT4 | LT5 | LT6 | . . . | LT(n − 1) | LTn |

Also, it may be useful to co-locate the storage of parameters in the sequence table to facilitate a process for re-programming or altering the timing or sequence of events in a display process. For instance, it is possible to re-arrange the order of the color subframes so that most of the red subframes are immediately followed by a green subframe, and the green subframes are immediately followed by a blue subframe. Such rearrangement or interspersing of the color subframes increase the nominal frequency at which the illumination is switched between lamp colors, which reduces the impact of CBU. By switching between a number of different schedule tables stored in memory, or by re-programming of schedule tables, it is also possible to switch between processes requiring either a lesser or greater number of bitplanes per color—for instance by allowing the illumination of 8 bitplanes per color within the time of a single image frame. It is also possible to re-program the timing sequence to allow the inclusion of subframes corresponding to a fourth color LED, such as the white lamp 146 depicted in FIG. 1B.

The display process 500 can be implemented to establish gray scales or luminance levels according to a coded word by associating each subframe image with a distinct illumination value based on the pulse width or illumination period in the lamps. Alternate options are available for expressing illumination value. In one alternative, the illumination periods allocated for each of the subframe images are held constant and the amplitude or intensity of the illumination from the lamps is varied between subframe images according to the binary ratios 1, 2, 4, 8, etc. For such an implementation, the format of the sequence table is changed to assign unique lamp intensities for each of the subframes instead of a unique timing signal. In some other implementations, both the variations of pulse duration and pulse amplitude from the lamps are employed and both specified in the sequence table to establish luminance level distinctions between subframe images.

FIG. 6 shows an example timing diagram 600 that corresponds to a coded-time division gray scale addressing process in which image frames are displayed by displaying four sub-frame images for each color component of the image frame. The timing diagram may be implemented by the controller 134 depicted in FIG. 1B. Therefore, the timing diagram 600 is described below in reference to FIG. 6 and FIG. 1B.

The timing diagram 600 uses the parameters listed below in Table 2. Each subframe image displayed of a given color is displayed at the same intensity for half as long a time period as the prior subframe image, thereby implementing a binary weighting scheme for the subframe images. The timing diagram 600 includes subframe images corresponding to the color white, in addition to the colors red, green and blue, which are illuminated using a white lamp. The addition of a white lamp allows the display to display brighter images or operates its lamps at lower power levels while maintaining the same brightness level. As brightness and power consumption are not linearly related, the lower illumination level operating mode, while providing equivalent image brightness, consumes less energy. In addition, white lamps are often more efficient, i.e., they consume less power than lamps of other colors to achieve the same brightness.

More specifically, the display of an image frame in timing diagram 600 begins upon the detection of a vsync pulse. As indicated on the timing diagram and in the Table 2 schedule table, the bitplane R3, stored beginning at memory location M0, is loaded into the array of light modulators 150 (depicted in FIG. 1B) in an addressing event that begins at time AT0. Once the controller 134 (depicted in FIG. 1B) outputs the last row data of a bitplane to the array of light modulators 150, the controller 134 outputs a global actuation command. After waiting the actuation time, the controller 134 causes the red lamp to be illuminated. Since the actuation time is a constant for all subframe images, no corresponding time value needs to be stored in the schedule table store to determine this time. At time AT4, the controller 134 begins loading the first of the green bitplanes, G3, which, according to the schedule table, is stored beginning at memory location M4. At time AT8, the controller 134 begins loading the first of the blue bitplanes, B3, which, according to the schedule table, is stored beginning at memory location M8. At time AT12, the controller 134 begins loading the first of the white bitplanes, W3, which, according to the schedule table, is stored beginning at memory location M12. After completing the addressing corresponding to the first of the white bitplanes, W3, and after waiting the actuation time, the controller causes the white lamp to be illuminated for the first time.

Because all the bitplanes are to be illuminated for a period longer than the time it takes to load a bitplane into the array of light modulators 150, the controller 134 extinguishes the lamp illuminating a subframe image upon completion of an addressing event corresponding to the subsequent subframe image. For example, LT0 is set to occur at a time after AT0 which coincides with the completion of the loading of bitplane R2. LT1 is set to occur at a time after AT1 which coincides with the completion of the loading of bitplane R1.

The time period between vsync pulses in the timing diagram is indicated by the symbol FT, indicating a frame time. In some implementations, the addressing times AT0, AT1, etc. as well as the lamp times LT0, LT1, etc. are designed to accomplish 4 subframe images for each of the four colors within a frame time FT of 16.6 milliseconds, i.e., according to a frame rate of 60 Hz. In some other implementations, the time values stored in the schedule table store can be altered to accomplish four subframe images per color within a frame time FT of 35.3 milliseconds, i.e., according to a frame rate of 30 Hz. In some other implementations, frame rates as low as 24 Hz may be employed or frame rates in excess of 100 Hz may be employed.

TABLE 2
Schedule Table 2

| | Field | Field | Field | Field | Field | Field | Field | . . . | Field | Field |
|---|---|---|---|---|---|---|---|---|---|---|
| | 1 | 2 | 3 | 4 | 5 | 6 | 7 | . . . | n − 1 | n |
| addressing | AT0 | AT1 | AT2 | AT3 | AT4 | AT5 | AT6 | . . . | AT(n − 1) | ATn |
| time | | | | | | | | | | |
| memory | M0 | M1 | M2 | M3 | M4 | M4 | M6 | . . . | M9(n − 1) | Mn |
| Location of | | | | | | | | | | |
| subframe | | | | | | | | | | |
| dataset | | | | | | | | | | |
| Lamp ID | R | R | R | R | G | G | G | . . . | W | W |

The use of white lamps can improve the efficiency of the display. The use of four distinct colors in the subframe images requires changes to the data processing in the controller 134 (depicted in FIG. 1B). Instead of deriving bitplanes for each of three different colors, a display process according to timing diagram 600 requires bitplanes to be stored corresponding to each of four different colors. The controller 134 may therefore convert the incoming pixel data, encoded for colors in a 3-color space, into color coordinates appropriate to a 4-color space before converting the data structure into bitplanes.

In addition to the red, green, blue and white lamp combination, shown in the timing diagram 600, other lamp combinations are possible which expand the space or gamut of achievable colors. A useful 4-color lamp combination with expanded color gamut is red, blue, true green (about 520 nm) plus parrot green (about 550 nm). Another 5-color combination which expands the color gamut is red, green, blue, cyan and yellow. A 5-color analogue to the YIQ NTSC color space can be established with the lamps white, orange, blue, purple and green. A 5-color analog to the well known YUV color space can be established with the lamps white, blue, yellow, red and cyan.

Other lamp combinations are possible. For instance, a useful 6-color space can be established with the lamp colors red, green, blue, cyan, magenta and yellow. A 6-color space also can be established with the colors white, cyan, magenta, yellow, orange and green. A large number of other 4-color and 5-color combinations can be derived from amongst the colors already listed above. Further combinations of 6, 7, 8 or 9 lamps with different colors can be produced from the colors listed above. Additional colors may be employed using lamps with spectra which lie in between the colors listed above.

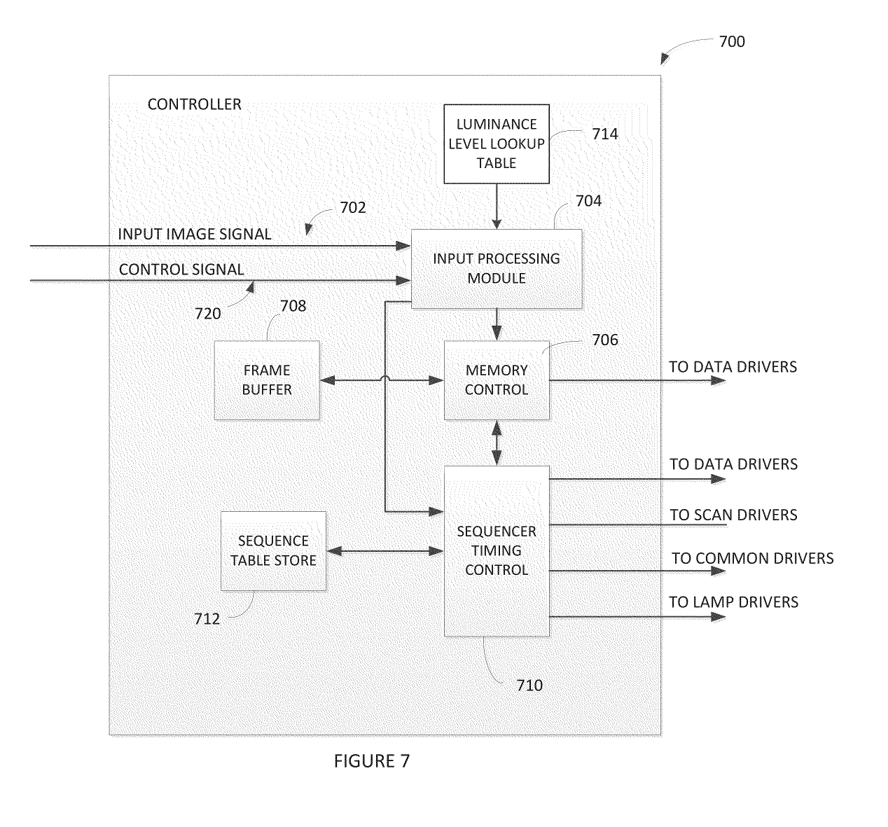

FIG. 7 shows a block diagram of an example controller 700 for use in a display. For example, the controller 700 may serve as the controller 134 depicted in FIG. 1B. Thus, FIG. 7 is described below in relation to FIGS. 1B and 7.

The controller 700 is configured to generate subframe images for display in part by using/and or selecting a variable composite color replacement multiplier, a, to adjust a fraction of the luminance of an image frame output as a composite color, i.e., a color that is substantially a combination of at least two other contributing colors output by the display. As set forth above, the contributing colors that combine to form the composite colors are referred to herein as “component colors.”

In general, the controller 700 receives an image signal 702 from an image source and generates outputs data and control signals to the drivers 130, 132, 138 and 148 to control the light modulators in the array of light modulators 150 and the lamps 140, 142, 144 and 146 of the display apparatus 128 (all depicted in FIG. 1B). The order in which the data and control signals are output is referred to herein as an “output sequence,” described further below. While the functionality of the controller 700 is described herein with respect to display apparatus incorporating light modulators, e.g., MEMS shutters, MEMS mirrors, LCD or electro-wetting cells, etc., the functionality also is applicable for emissive displays, such as OLED-based displays.

To carry out the above described functionality, the controller 700 includes an input processing module 704, a memory control module 706, a frame buffer 708, a timing control module 710 and a schedule table store 712. In some implementations, these components may be provided as distinct chips or circuits which are connected together by means of circuit boards, cables, or other electrical interconnects. In some other implementations, several of these components can be designed together into a single semiconductor chip such that their boundaries are nearly indistinguishable except by function. In some other implementations, some of the components can be implemented in firmware or software executing on a microprocessor incorporated into the controller 700.

Still referring to FIGS. 1B and 7, the input processing module 704 receives the image signal 702 as input and processes the data encoded therein into a format suitable for displaying via the array of light modulators 150 depicted in FIG. 1B. To that end, the input processing module 704 takes the data encoding each image frame and converts it into a series of sub-frame data sets. A sub-frame data set includes information about the desired states of modulators in multiple rows and multiple columns of the array of light modulators 150 aggregated into a coherent data structure. The number and content of sub-frame data sets used to display an image frame depends on the grayscale technique employed by the controller 700. In general, a gray scale technique refers to a process by which the display apparatus varies the luminance level output for a given contributing color of the display. For example, the sub-frame data sets used to form an image frame using a coded time-division gray scale technique differ from the number and content of sub-frame data sets used to display an image frame using a non-coded time division gray scale technique. In various implementations, the input processing module 704 may convert the image signal 705 into non-coded sub-frame data sets, bitplanes, ternary coded sub-frame data sets, or other form of coded sub-frame data set. To facilitate the translation of the incoming image data into sub-frame data sets, the input processing module 704 accesses a set of luminance level look-up tables (LUTs) 714 that store conversions of luminance values of each of the contributing colors of the display into series of pixel states that create the desired luminance value. The controller 700 can be implemented to include at least one luminance level LUT associated with each contributing color for an imaging mode implemented by the controller 700. A given luminance level LUT may be associated with one or more contributing colors for one or more imaging modes.

The input processing module 704 outputs the sub-frame data sets to the memory control module 706. The memory control module 706 then stores the sub-frame data sets in the frame buffer 708. The frame buffer is 708 preferably a random access memory, although other types of serial memory also can be used. The memory control module 706, in some implementations, stores the sub-frame data set in a predetermined memory location based on the color and significance in a coding scheme of the sub-frame data set. In some other implementations, the memory control module 706 stores the sub-frame data set in a dynamically determined memory location and stores that location in a lookup table for later identification.

The memory control module 706 also can be responsible for, upon instruction from the timing control module 710, retrieving sub-frame data sets from the frame buffer 708 and outputting them to the data drivers 132 (depicted in FIG. 1B). The data drivers 132 load the data output from the memory control module 706 into the light modulators of the array of light modulators 150. The memory control module 706 outputs the data in the sub-image data sets one row at a time. In some implementations, the frame buffer 708 includes two buffers, whose roles alternate. While the memory control module 706 stores newly generated sub-frame data sets corresponding to a new image frame in one buffer, it can extract sub-frame data sets corresponding to the previously received image frame from the other buffer for output to the array of light modulators 150. In some implementations, both buffer memories can reside within the same circuit, separated only by address.

The timing control module 710 manages the output by the controller 700 of data and command signals according to an output sequence. The output sequence includes the order and timing with which sub-frame data sets are output to the array of light modulators 150 (depicted in FIG. 1B) and the timing and character of illumination events. The output sequence, in some implementations, also includes global actuation events. At least some of the parameters that define the output sequence are stored in volatile memory. This volatile memory is referred to as a schedule table store 712. The schedule table store 712 stores one or more schedule tables as described above in relation to FIGS. 5 and 6.

The output sequence parameters stored in the schedule table store 712 vary in different implementations of the display apparatus disclosed herein. In some implementations, the schedule table store 712 stores timing values associated with each sub-frame data set. For example, the schedule table store 712 may store timing values associated with the beginning of each addressing event in the output sequence, as well as timing values associated with lamp illumination and/or lamp extinguishing events. In some other implementations, the schedule table store 712 stores lamp intensity values instead of or in addition to timing values associated with addressing events. In various implementations, the schedule table store 712 stores an identifier indicating where each sub-image data set is stored in the frame buffer 708, and illumination data indicating the color or colors associated with each respective sub-image data set.

The nature of the timing values stored in the schedule table store 712 can vary depending on the specific implementation of the controller 700. The timing value, as stored in the schedule table store 712, in some implementations, is a number of clock cycles, which for example, have passed since the initiation of the display of an image frame, or since the last addressing or lamp event was triggered. Alternatively, the timing value may be an actual time value, stored in microseconds or milliseconds.

Address data in the schedule table can be stored in a number of forms. For example, the address is a specific memory location in the frame buffer 708 of the beginning of the corresponding bitplane, referenced by buffer, column and row numbers. In another implementation, the address stored in the schedule table store 712 is an identifier for use in conjunction with a sub-frame data set lookup table maintained by the memory control module 706. For example, the identifier may have a simple 6-bit binary word structure where the first 2 bits identify the color associated with the bitplane, while the next 4 bits refer to the significance of the bitplane. The actual memory location of the bitplane is then stored in a lookup table maintained by the memory control module 706 when the memory control module 706 stores the bitplane into the frame buffer. In some other implementations the memory locations for bitplanes in the output sequence may be stored as hardwired logic within the timing control module 710.

The timing control module 710 may retrieve schedule table entries using several different processes. In some implementations, the order of entries in the schedule table is fixed; the timing control module 710 retrieves each entry in order until reaching a special entry that designates the end of the sequence. Alternatively, a sequence table entry may contain codes that direct the timing control module 710 to retrieve an entry which may be different from the next entry in the table. These additional fields may incorporate the ability to perform jumps, branches and looping in analogy with the control features of a standard microprocessor instruction set. Such flow control modifications to the operation of the timing control module 710 allow a reduction in the size of the sequence table.

The input processing module 704 of the controller 700 also receives control signals 720 from other components of the host device. As described with respect to FIG. 1B, the controller 700 can receive control signals 720 from the host processor 122, environmental sensors and/or various user interface devices. Based on the control signals 720, the input processing module 704 selects an imaging mode for use in outputting received image data. The selection of the imaging mode in turns governs the selection of the appropriate luminance level LUTs 714 and sequence tables stored in the sequence table store 712. The control signals 720 can include explicit instructions with respect to imaging mode selection, or it can include data from which the input processing module 704 can process to select an imaging mode. For example, the control signals can include ambient light data, power savings mode data, battery level data, user preference data and/or content metadata. In certain implementations, the input processing module 704 processes the control signals 720 in conjunction with the actual content of the input image signal 702 to select an appropriate imaging mode.

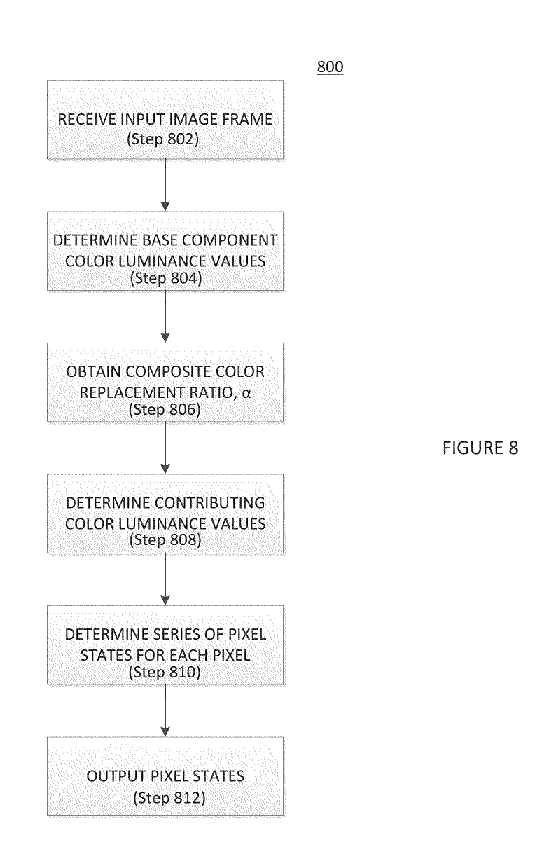

FIG. 8 shows a flow diagram of an example process 800 of displaying images according to a variable composite color replacement policy. The process 800 may be implemented, for example, by the controller 700 depicted in FIG. 7. Referring to FIGS. 7 and 8, the process 800 begins with the controller 700 receiving an input image frame (block 802). From the image frame, the input processing module 704 determines for each of the pixels the luminance values for each of colors in the input data stream (block 804). The controller 700 then obtains a composite color replacement multiplier, a, of each pixel (block 806). Based on the obtained values of a, the controller 700 determines for each pixel a set of luminance levels for each of the contributing colors being output by the display (block 808) and corresponding series of pixel states that are be used to generate the luminance levels (block 810). The controller then outputs the pixel states to the array of light modulators 150 (block 812). Each of these stages is described further below.

As set forth above, the process 800 for displaying images begins with the controller 700 receiving an input image frame (block 802). The controller 700 can receive the input image frame from a host processor, such as the host processor 122 depicted in FIG. 1B, from a memory device, or any other image source. The image frame, in some implementations, includes a frame of video content. The image frame identifies color luminance values for a plurality of colors for a set of pixels. Typically, the input image frame includes separate red, green and blue luminance values for each pixel, encoded, for example in binary-weighted bit stream, though other formats may be.

Based on the received image frame, the controller determines a set of base output color luminance values for each pixel of the display (block 804). The initial luminance values may be set equal to the luminance values included in the input image signal. Alternatively, the input processing module 704 may carry out various pre-processing procedures on the input image signal to obtain the base output color luminance values. For example, the input processing module 704 may scale the input image to the number of pixels included in the array of light modulators 150 depicted in FIG. 1B. In addition, the input processing module 704 may execute one or more spatial dithering, temporal dithering, or gamma correction processes to further adapt the luminance values received in input image signal to the output characteristics of the display apparatus. For the purposes of this disclosure, it is considered that a color output by a display that is substantially similar to the result of such pre-processing should also be considered substantially similar to the actual input color received by the controller.

The controller 700 obtains a composite color replacement multiplier, a, to be used for each pixel. In some implementations of the process 800, the controller 700 obtains a single a value for use for every pixel of an image frame. In some other implementations, the controller 700 obtains an a value for each pixel, or for groups of pixels. For example, the controller may assign a value to all pixels in an application window. Alternatively, the controller may be configured to arbitrarily assign one value of a to one portion of the image frame, such as the top half, and another a value to a different portion, such as the lower half. In some implementations, the controller 700 is configured to identify values for a embedded in the input image signal 702 or included in the control signals 720. In some other implementations, the controller 700 selects values of a for itself for every pixel. As a result, in many image frames, two pixels corresponding to the same input color in the same image frame may be generated using two different values of a, and thus two different luminance levels of a composite color. Similarly, in some situations, in two sequential frames, the same input color may be generated at the same display location with two different luminance levels for the composite color.

In some implementations, this selection process can be straightforward, such as by assigning each pixel a random a value or by applying a pre-stored pattern of a usage (e.g., alternating a values according to a checkerboard pattern). In some other implementations, it may be more complex. For example, the controller can be implemented to take into account one or more of the following parameters:
The pixel input color for one or more neighboring pixels;
Tristimulus values having a known propensity for inducing image artifacts;
An average luminance of the composite color over a group of pixels;
An average luminance of the composite color over the entire image frame;
A rate of change of pixel luminance and/or image frame luminance from a previous set of image frames;
Metadata indicating a software application generating the image data to be output by the pixel; and
Metadata indicating a type of content associated with the pixel.
   The specific algorithm employed to select alpha will differ from display-to-display, and in some cases from imaging mode-to-imaging mode. However, some common principles generally apply.

For example, a values tend to be proportional to the overall luminance of the composite color of a group of pixels to reduce CBU artifacts. Thus, assuming the composite color is white, if a group of pixels has a great deal of white content, a controller will tend to select a higher value of a for that group of pixels. The controller may determine that the group of pixels has a high white content by analyzing the image data directly. Alternatively, the controller may determine the high white content based on the identification of a software application associated with a software application window providing the image date for output at those pixels. For example, many office applications, such as word processing and spreadsheet documents, tend to utilize substantially white backgrounds. Thus, metadata indicating a group of pixels is associated with a window in which the output of a spreadsheet or word processing document is being output can be processed by the controller to select a higher value for a for the group of pixels. In the alternative to looking at a group of pixels, for example, associated with an application window, the controller can take an average luminance of the composite color of the entire image frame.

Similarly, a controller generally tends to select a values to be inversely proportional to the full composite color replacement value, M, for the input color of a pixel. For an input color, M is equal to the luminance level of the composite color at which the output of the composite color fully replaces the need to output any light of the component color having the lowest luminance level, without the chromaticity or brightness associated with color tristimulus values of the output pixel color differing substantially from the brightness and chomaticity associated with the tristimulus values of the input pixel color. As understood by a person of ordinary skill in the art, a color can be fully described (in terms of both its chromaticity and brightness) by its corresponding set of tristimulus values. As the full composite color replacement value falls, the less illumination the display apparatus may provide using a composite color. Thus, the controller tends to increase alpha as the value of M falls to ensure it is able to take advantage of the composite color.

In another implementation, as mentioned above, the controller takes into account the input colors associated with neighboring pixels. For example, the controller can store a list of pairs of contributing color intensities, which if generated in adjacent pixels, have a higher likelihood of resulting in DFC. For example, assuming an 8-bit binary weighting scheme, displaying two pixels neighboring one another that have luminance values of 127 and 128 for a common contributing color, respectively, has been found to have an increased likelihood of detectable DFC. Thus, controllers configured according to this implementation would select a value of a for one of the two neighboring pixels that would result in contributing color luminance values that avoid this particular pairing, or other pairings determined to lead to increased DFC. In some other implementations, the controller is configured to avoid any pixel having a luminance value that may be likely to lead to increased DFC, regardless of any neighboring pixel values. For example, with an 8-bit binary weighting scheme, the controller selects values for a such that no pixel has a luminance value of 127 or 128 or other value determined to lead to increased DFC. Similarly, it has been found that displaying yellow pixels next to white pixels can lead to image artifacts. Thus, in some implementations, the controller applies a lower value for a to white pixels that neighbor a yellow pixel. In some other implementations, the controller applies a randomly selected value for a to all white pixels in an image frame if the image frame includes any yellow pixels.

In some implementations, the controller proceeds further to actively offset DFC contributions from different contributing colors by selecting values for a that result in the contributing colors having luminance values that offset their respective contributions to DFC. In general, the DFC contribution of a particular code word for a contributing color can be calculated according to the following equation:

D(x)−Σ [symbol] [Abs({M [symbol] (x)}−{M [symbol] (x−1)}) [symbol] W [symbol] ] eq. (1),

where x is the given luminance level associated with the code word, M [symbol] (x) is the bit value for that luminance level, W [symbol] is weight for bit i., N is the total number of bits of the color in the code word and Abs is the absolute value function.

Using equation (1), during the design phase of the controller, various levels of a can be analyzed in the generation of a range of input colors to identify specific a values that are appropriate for given input color values to achieve the above described DFC offset. These values can then be stored in a lookup table on the controller for operation of the display.

Another factor identified above as being pertinent to a value selections is the rate of change of pixel or overall image brightness from frame to frame. Generally, the controller selects lower values of a as the rate of change of pixel or image frame brightness increases.

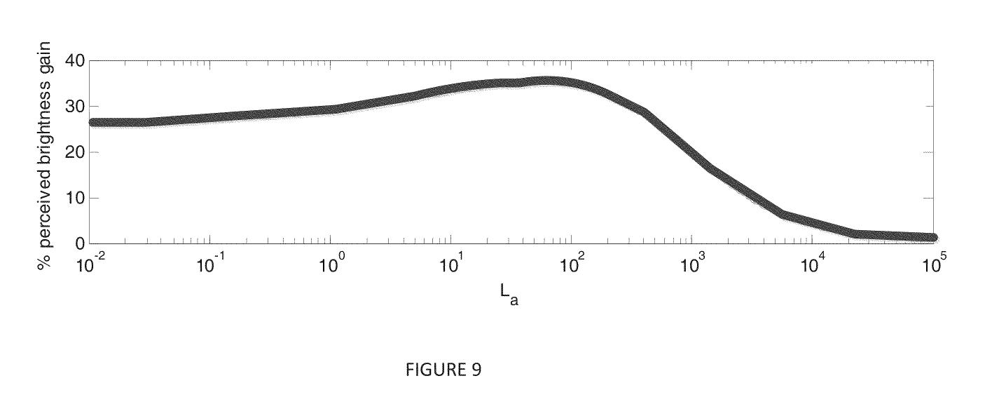

In addition to adjusting the level of a used to generate a pixel color based on image quality concerns, the display controller 700 can be configured to adjust a to modify power consumption characteristics of the display. Two countervailing energy efficiency phenomena are relevant to the selection of a. First, composite color LEDs, particularly white LEDs tend to be substantially more efficient than component color LEDs. At the same time, however, as described above, the human visual system perceives white light generated from a combination of saturated light sources, e.g., red, green and blue LEDs, as substantially brighter than the identical light intensity output by a broad spectrum white LED. This is referred to as the HK Effect. The degree of increased perceived brightness is a function of ambient light levels, wherein the increase of perceived brightness decreases at higher ambient light levels. FIG. 9 shows a diagram depicting perceived brightness gains obtained at various ambient light levels by outputting white light using a combination of saturated colors due to the HK Effect.

To take advantage of these competing phenomena to control power consumption, in some implementations, one of the environmental sensors 124 of the display apparatus 128 depicted in FIG. 1B is an ambient light sensor. The ambient light sensor outputs ambient light data to the controller, either directly or through a host processor, for use in selecting a. For example, at higher levels of ambient light, e.g., where the gained perceived brightness from generating white light using saturated component colors falls below a threshold, the controller increases the value of a used to form images. The threshold is preferably set at a point beyond which the actual luminance efficiency gained by using a white LED exceeds the perceived brightness gain achieved by using saturated colors. In some implementations, the threshold is set to the ambient light level at which the HK Effect provides about a 20% efficiency gain.

In some implementations, the HK Effect evaluation serves as a gating feature to using any composite color replacement. That is, a is set to 0, unless ambient lighting conditions suggest some power savings might be obtained by using the composite color. Alternatively, the controller selectively increases an otherwise determined a if the HK Effect evaluation suggests a power savings is available from increasing use of the composite color. In still alternative implementations, the controller stores a multi-dimensional lookup table populated during the design phase of the controller using a neural network or genetic algorithms to identify values of a that are optimal, or at that at least yield improved performance, for any combination of image and/or energy-based input parameters.

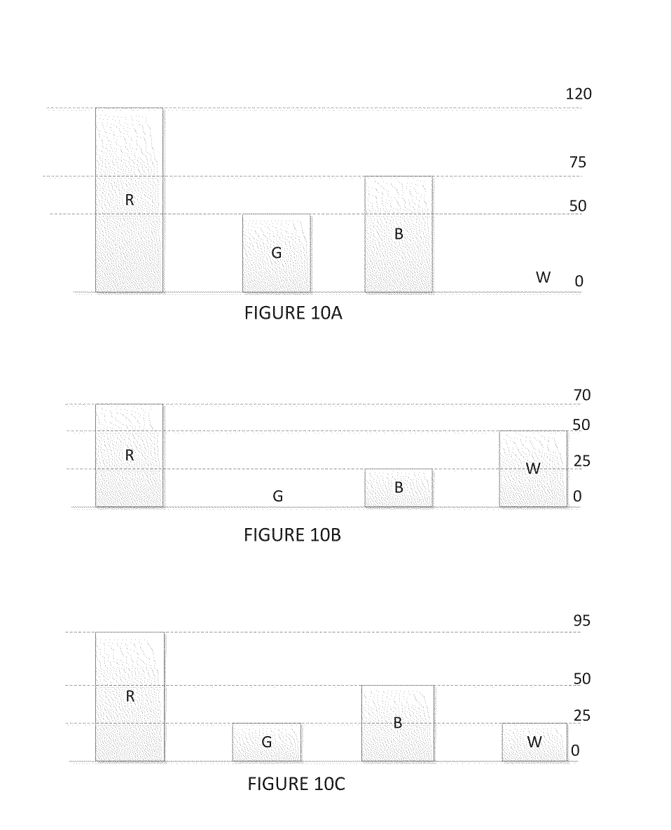

FIGS. 10A-10C show example graphical depictions of how output luminance values for a pixel can be determined based on a value of a. FIGS. 10A-10C assume a common pixel input color having component color luminance values of red 120, green 50, blue 75. FIG. 10A depicts the contributing color luminance levels output by a display to generate the input pixel value using a=0. FIG. 10B depicts the contributing luminance levels output by a display to generate the input pixel value using a=1. FIG. 10C depicts the contributing color luminance levels output by a display to generate the input pixel value using a=0.5. By adjusting each of the contributing color luminance levels appropriately based on the value of a, the tristimulus values, and hence the chromaticity and brightness, of the colors generated by the combined outputs of the contributing colors in each of FIGS. 10A-10C are substantially the same.

FIG. 10A depicts the luminance levels output by a display for a pixel having an input pixel color of red 120, green 50, blue 75, using a=0. Color output using a=0 corresponds to the output without the use of a composite color, and is instead formed solely with non-composite contributing colors. Each component color is emitted at a luminance level matching the luminance level indicated in the input pixel color, i.e., red 120, green 50 and blue 75.

FIG. 10B depicts the contributing color luminance levels used to generate the same output pixel color using a=1, i.e., the full composite color replacement value. The full composite color replacement value for this input color is 50, as the lowest intensity level of the component colors is 50, for green. By providing a composite color output of 50, the need to provide any output of green for the pixel is substantially eliminated, and the luminance level of red and blue also can be reduced by 50 to 70 and 25, respectively. The combined output of the contributing colors results in color trisimulus values having substantially the same chromaticity and brightness as the tristimulus values associated with the color obtained from the combined outputs of the contributing colors of FIG. 10A.

FIG. 10C depicts the contributing color luminance levels using a=0.5. That is, the composite color is output at, and the component color luminances are reduced by, 50% of the full composite color replacement value, in this case, by 25. As a result, the display outputs luminance levels of red: 95, green 25, blue, 50 and white 25. The combined output of the contributing colors results in color trisimulus values having substantially the same chromaticity and brightness as the tristimulus values associated with the color obtained from the combined outputs of the contributing colors of FIGS. 10A and 10B.

As can be seen from the above example, by selecting different values of a, a controller can alter the luminance level of each of the contributing colors (component and composite) used to generate a given output pixel color. As different component color luminance levels translate to different series of pixel states (as described further below), varying a provides another means, instead of or in addition to employing code word degeneracy, for altering the temporal distribution of light emission across a display, thereby mitigating related image artifacts.

Referring back to FIGS. 7 and 8, based on the obtained values of a, the controller 700 calculates new output luminance values for each pixel for each of the contributing colors (block 808). In some implementations, the processor 700 calculates the new luminance values (block 808) directly. For example, assuming the processor receives input color data in the form of intensity values for n component colors (e.g., red, green and blue for n=3) the processor can be configured to carry out the following algorithm:

M=min[ICcomponₒ,ICompon₁, . . . ICcomponₙ₋₁] eq. (2);

OCcompos=a*M eq. (3); and

OCcompon₁=ICcomponᵢ−OCcompos eq. (4),

where OCcompos is the luminance level to be output for the composite color source, ICcomponᵢ is the input luminance value for component color i and OCcomponᵢ is the luminance level to be output for component color i.

In some implementations, any fractional luminance values are rounded to the nearest whole number. According to another implementation, during the design phase of the controller, the impact of rounding is analyzed based on the possible resulting contributions to DFC if a luminance value is rounded one way or another, and a lookup table is generated for use by the controller to determine the appropriate luminance values based on the analysis. In still another implementation, after all the output luminance values are calculated, the controller applies a dithering algorithm to correct for any distribution errors resulting from the composite color subtraction process.

Using the new output luminance values, the controller 700 obtains a set of pixel states (block 810) for each pixel in the image frame to generate subframe data sets that will be used to form the image frame on the display. In some implementations, the controller 700 stores a single luminance level lookup 714 table for each contributing color. As set forth above, the luminance level lookup table 714 stores respective sets of pixel states to be used to generate each luminance value the display is capable of generating for the contributing color. The sets of pixel states are stored in the form of strings of values, such as “1”s or “0”s, where a 1 corresponds to a pixel state of “on” and a 0 corresponds to pixel state of “off.” The string of values is referred to as code word. In some implementations, the controller 700 shares a single luminance level lookup table 714 for multiple contributing colors.

In some other implementations, the controller employs both code word degeneracy and varying a techniques. In some of such implementations, the controller stores 700 multiple luminance level LUTs 714 for at least one of the contributing colors, where each luminance level lookup table 714 is associated with a value, or range of values, for a. In these implementations, before obtaining pixel states for a given pixel, the controller 700 first selects the appropriate luminance level lookup table 714 based on the value of a used for the pixel. In some other implementations, the multiple luminance level LUTs 714 per contributing color are not tied to specific a values. Instead, the controller 700 selects a particular luminance level LUT 714 to use on a pixel-by-pixel, group of pixel-by-group of pixel, or image frame-by-image frame basis to mitigate potential image artifacts, such as DFC and CBU. For instance, in some implementations, the controller alternates between two different luminance level LUTs for each contributing color on a pixel-by-pixel or group of pixel-by-group of pixel basis in a checkerboard fashion, in alternating image frames, or according to any other suitable temporal or spatial pattern stored by or implemented in the controller. In some other implementations, the controller 714 dynamically selects an appropriate luminance level LUT 714 based on the luminance levels of the contributing colors associated with each pixel to avoid two pixels presenting two sets of pixel states that are known to promote DFC, CBU, or other image artifacts. This determination, in some implementations, also factors in the a value(s) obtained for the corresponding pixel or group of pixels.

The controller 700 converts the set of pixel states obtained from the luminance level LUTs 714 for all of the pixels into a set of subframe data sets, which are stored in the frame buffer 708. Finally, the controller 700 outputs the derived subframe datasets to the array of light modulators according to the stored output sequence (block 812).

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus, comprising:
a plurality of pixels; and
a controller configured to control the amount of light emitted by the display apparatus for each of the pixels to display an image frame, wherein:
controlling the amount of light emitted by the display apparatus for a pixel includes controlling the luminance of at least four contributing colors emitted for the pixel in a plurality of corresponding subframe images or by a plurality of corresponding subpixels, at least one of the contributing colors is a composite color which substantially corresponds to a combination of at least two of the remaining contributing colors, and the combined luminance of the at least four contributing colors results in a pixel color having an associated set of color tristimulus values for the pixel; and
the controller is further configured to generate substantially the same color tristimulus values for first and second pixels of an image frame by causing le display apparatus to emit a different composite color luminance for the first pixel than for the second pixel.

2. The display apparatus of claim 1, wherein the composite color comprises one of white and yellow and the at least two remaining contributing colors comprise at least two of red, green and blue.

3. The display apparatus of claim 1, wherein the controller, for the image frame, is configured to cause the display apparatus to emit the contributing colors according to a field sequential color (FSC) display process.

4. The display apparatus of claim 1, wherein the controller is configured to select the luminance of the composite color to be emitted for the first pixel.

5. The display apparatus of claim 4, wherein the controller is configured to select the luminance of the composite color according to a spatial pattern implemented by the controller.

6. The display apparatus of claim 4, wherein the controller is configured to select the luminance of the composite color based on a graphical Characteristic of the image frame.

7. The display apparatus of claim 6, wherein the graphical characteristic, of the image frame comprises a chromaticity of a pixel color of at least one pixel neighboring the first pixel.

8. The display apparatus of claim 7, wherein the controller stores a data structure including data indicative of appropriate composite color luminances to be emitted for a pixel based on a plurality of chromaticities of pixel colors of at least one neighboring pixel.

9. The display apparatus of claim 6, wherein the controller is configured, for the first image frame, to calculate an average luminance of the composite color across the pixels, and the graphical characteristic of the image frame comprises the calculated average value.

10. The display apparatus of claim 6, wherein the controller is configured, for the first image frame, to calculate an average rate of change of pixel luminance with respect to a preceding image frame, and the graphical characteristic of the image frame comprises the calculated average rate of change.

11. The display apparatus of claim 4, wherein the controller is configured to select the luminance of the composite color based on metadata received by the controller indicative of a content type associated with the first pixel.

12. The display apparatus of claim 4, wherein the controller is configured to select the luminance of the composite color based on metadata received by the controller indicative of a software application supplying image data associated with the first pixel.

13. The display apparatus of claim 4, wherein the controller is configured to select the luminance of the composite color based on data received by the controller indicative of one of a battery level and power-usage mode.

14. The display apparatus of claim 4, wherein the controller is configured to determine, for the first pixel, a pixel state for each of a plurality of subframe images associated with each of the contributing colors based on the selected luminance of the composite color for the first pixel.

15. The display apparatus of claim 1, wherein:
the luminance of the composite color emitted for the first pixel corresponds to a first composite color replacement multiplier (a₁), wherein a₁ is indicative of a fraction of a first full composite color replacement value (M₁) associated with the pixel color tristimulus values, and M₁ corresponds substantially to the maximum theoretical composite color output that can be used to offset output of the at least, two of the remaining contributing colors in the generation of the pixel color without substantially altering the chromaticity or brightness associated with the pixel color tristimulus values;
the luminance of the composite color emitted for the second pixel corresponds to a second composite color replacement multiplier (a₂), which is indicative of a second, different fraction of M₁; and
the controller is configured to select the luminance of the composite color for the first pixel and the second pixel by obtaining values for a₁ and a₂.

16. The display apparatus of claim 15, wherein the controller is configured to obtain values for at least one of a₁ and a₂ by processing image data associated with the image frame.

17. The display apparatus of claim 15, wherein the controller is configured to obtain values for at least one of a₁ and a₂ by processing image data associated with the image frame and at least a second image frame.

18. The display apparatus of claim 15, wherein the controller is configured to obtain values for at least one of a₁ and a₂ by processing metadata associated with the image frame.

19. The display apparatus of claim 15, comprising an ambient light sensor, and wherein the controller is configured to obtain values for at least one of a₁ and a₂ by processing data indicative of output of the ambient light sensor.

20. The display apparatus of claim 15, wherein the controller is configured to obtain values for at least one of a₁ and a₂ by processing data indicative of at least one of a battery level and a power-usage mode.

21. The display apparatus of claim 15, wherein the controller is configured to obtain values for at least one of a₁ and a₂ according to a spatial pattern implemented by the controller.

22. The display apparatus of claim 15, wherein the controller is configured to determine, for the first and second pixels, respective pixel states for each of a plurality of subframe images associated with each of the contributing colors based on the selected luminance of the composite color for the first and second pixels and based on the values of a₁ and a₂.

23. A controller for a display apparatus, comprising:
an image data input for receiving input pixel colors for a plurality of pixels of the display apparatus for an image frame; and
an image data processor configured to determine for a given pixel of the image frame, based on a corresponding set of color tristimulus values associated with a received input pixel color, luminance values for at least four contributing colors to be emitted by the display apparatus for the pixel in a plurality of corresponding subframe images or by a plurality of corresponding subpixels, wherein at least one of the contributing colors is a composite color which substantially corresponds to a combination of at least two of the remaining contributing colors, and the combined luminance of the at least four contributing colors results in a output pixel color having substantially the same set of color tristimulus values as the color tristimulus values associated with the input pixel color;
wherein the image processor is further configured to determine substantially different composite color luminance values for at least two pixels having the same input pixel color.

24. The controller of claim 23, wherein the composite color comprises one of white and yellow and the at least two remaining contributing colors comprise at least, two of red, green and blue.

25. The controller of claim 23, wherein the controller, for the image frame, is configured to cause the display apparatus to emit the contributing colors according to a field sequential color (FSC) display process.

26. The controller of claim 23, wherein the controller is configured to select the luminance of the composite color to be emitted for the first pixel.

27. The controller of claim 26, wherein the controller is configured to select the luminance of the composite color according to a spatial pattern implemented by the controller.

28. The controller of claim 26, wherein the controller is configured to select the luminance of the composite color based on a graphical characteristic of the image frame.

29. The controller of claim 26, wherein the controller is configured to select the luminance of the composite color based on metadata received by the controller in association with the image frame.

30. The controller of claim 26, wherein the controller is configured to select the luminance of the composite color based on data indicative of output of the ambient light sensor.

31. The controller of claim 23, wherein:
the luminance of the composite color emitted for the first pixel corresponds to a first composite color replacement multiplier (a₁), wherein a₁ is indicative of a fraction of a first full composite color replacement value (M₁) associated with the input pixel color, and M₁ corresponds substantially to the maximum theoretical composite color output that can be used to offset output of the at least two of the remaining contributing colors in the generation of the output pixel color the chromaticity and brightness associated output pixel tristimulus values are substantially the same as the chromaticity and brightness associated with the input color tristimulus values;
the luminance of the composite color emitted for the second pixel corresponds to a second composite color replacement multiplier (a₂), which is indicative of a second, different fraction of M₁; and
the controller is configured to select the luminance of the composite color far the first pixel and the second pixel by obtaining values for a₁ and a₂.

32. The controller of claim 31, wherein the controller is configured to determine, for the first and second pixels, respective pixel states for each of a plurality of subframe images associated with each of the contributing colors based on the selected luminance of the composite color for the first and second pixels and based on the values of a₁ and a₂.

35. The controller of claim 23, wherein the controller is configured to obtain values for at least one of a₁ and a₂ by processing data indicative of an output of an ambient light sensor.

34. The controller of claim 23, wherein the controller is configured to obtain values for at least one of a₁ and a₂ by processing data indicative of at least one of a battery level and a power-usage mode.

35. A controller for a display apparatus, comprising:
an image data input for receiving input pixel colors for a plurality of pixels of the display apparatus for an image frame; and
an image data processor configured to determine for a given pixel of the image frame, based on a corresponding received input pixel color, luminance values for at least four contributing colors to be emitted by the display apparatus for the pixel in a plurality of corresponding subframe images or by a plurality of corresponding subpixels, wherein at least one of the contributing colors is a composite color which substantially corresponds to a combination of at least two of the remaining contributing colors, and the combined luminance of the at least four contributing colors results in an output pixel color for the pixel which is substantially similar to the input pixel color;
wherein
the luminance of the composite color emitted for a first pixel corresponds to a first composite color replacement multiplier (a₁), wherein a₁ is indicative of a fraction of a first full composite color replacement value (M₁) associated with the input pixel color of the first pixel, and M₁ corresponds substantially to the maximum theoretical composite color output that can be used to offset output of the at least two of the remaining contributing colors in the generation of the input pixel color of the first pixel on the display apparatus without the chromaticity or brightness associated with a set of tristimulus values for the output pixel color for the first pixel differing substantially from the chromaticity or brightness associated with a set of tristimulus values far the input pixel color for the first pixel;
the luminance of the composite color emitted far a second pixel corresponds to a second composite color replacement multiplier (a₂), wherein a₂ is indicative of a fraction of a second full composite color replacement value (M₂) associated with the input pixel color of the second pixel, and M₂ corresponds substantially to the maximum theoretical composite color output that can be used to offset output of the at least two of the remaining contributing colors in the generation of the input pixel color of the second pixel on the display apparatus without the chromaticity or brightness associated with the tristimulus values for the output pixel color for the second pixel differing substantially from the chromaticity or brightness associated with tristimulus values of the input pixel color for the second pixel; and
the controller is configured to select a₁ and a₂ such that a₁ is greater than a₂.

36. The controller of claim 35, wherein the controller is configured to determine values for R₁, and R₂ and determine luminance values for each of the contributing colors for the first and second pixels based on the values for a₁, a₂, M₁, and M₂.

37. The controller of claim 35, wherein the controller is further configured to select for each of the contributing colors, states of the first and second pixel for each subframe image or subpixel associated with the image frame, wherein the selection of the states of the first and second pixel are based on the determined luminance values for the contributing colors and the values of a₁ and a₂.

38. The controller of claim 35, wherein:
the controller stores at least two data structures identifying series of pixel states for generating a plurality of luminance levels of at least one contributing color;
for the first pixel, the controller selects one of the data structures for utilization based on the value of a₁, and
for the second pixel, the controller selects one of the data structures for utilization based on the value of a₂.

39. The controller of claim 35, wherein the controller is configured to obtain values for at least one of a₁ and a₂ by processing image data associated with the image frame.

40. The controller of claim 35, wherein the controller is configured to obtain values for at least one of a₁ and a₂ by processing image data associated with the image frame and at least a second image frame.

41. The controller of claim 35, wherein the controller is configured to obtain values for at least one of a₁ and a₂ by processing metadata associated with the image frame.

42. The controller of claim 35, wherein the controller is configured to obtain values for at least one of a₁ and a₂ by processing data indicative of output of an ambient light sensor.

43. The controller of claim 35, wherein the controller is configured to obtain values for at least one of a₁ and a₂ by processing data indicative of at least one of a battery level and a power-usage mode.

44. The controller of claim 35, wherein the controller is configured to obtain values for at least one of a₁ and a₂ according to a spatial pattern implemented by the controller.

45. The controller of claim 35, wherein the composite color comprises one of white and yellow and the at least two remaining contributing colors comprise at least two of red, green and blue.

46. The controller of claim 35, wherein the controller, for the image frame, is configured to cause the display apparatus to emit the contributing colors according to a field sequential color (FSC) display process.

47. The controller of claim 35, wherein the controller, for the image frame, is configured to cause the display apparatus to emit the contributing colors according to a field sequential color (FSC) display process.
